(19) United States
(12) Patent Application Publication
(10) Pub. No.: US 2015/0239197 A1
(43) Pub. Date: Aug. 27, 2015

(54) ARTICLE AND LAMINATE

(71) Applicant: SUMITOMO BAKELITE CO., LTD., Tokyo (JP)

(72) Inventors: Takeshi Hosomi, Tokyo (JP); Tatsumi Kawaguchi, Tokyo (JP); Yasutaka Kimura, Tokyo (JP)

(73) Assignee: SUMITOMO BAKELITE CO., LTD., Tokyo (JP)

(21) Appl. No.: 14/432,400

(22) PCT Filed: Sep. 2, 2013
(86) PCT No.: PCT/JP2013/073515

§ 371 Date: Mar. 30, 2015

(30) Foreign Application Priority Data
Oct. 2, 2012 (JP) 2012-220293

(51) Int. Cl. B32B 1/02; B32B 15/08; B32B 27/20; B32B 3/26; B32B 27/08

(52) U.S. Cl. CPC B32B 1/02; B32B 3/266; B32B 27/08; B32B 27/20; B32B 15/08; B32B 2262/103; B32B 2307/212; B32B 2439/00

(57) ABSTRACT

According to the present invention, there is provided an article including: a main body portion (10) that is formed of a material composition containing a fiber filler and a resin and obtained using a paper-making method; and a functional layer (20) that covers the main body portion (10).

### TECHNICAL FIELD

The present invention relates to an article and a laminate.

### BACKGROUND ART

In recent years, cases having various characteristics have been required in the field of electronics which includes laptop computers or mobile phones, or in the field of automobiles. In these fields, for the purpose of saving energy, miniaturizing, or shielding electromagnetic waves of a product, various techniques related to a case with excellent electromagnetic wave shielding performance or thermal conductivity have been suggested (for example, Patent Documents 1 and 2).

However, when the environment or the like for which the product is used is considered, it is insufficient to specify the characteristic of the case with only electromagnetic wave shielding performance or thermal conductivity and thus various characteristics such as abrasion resistance, waterproof properties, design properties, impact resistance, and flame retardance have been required.

For example, Patent Document 3 discloses a technique that provides an electronic device case whose wireless communication performance is not degraded while maintaining radio wave shielding properties and which has particularly excellent design properties.

### RELATED DOCUMENTS

### Patent Documents

[Patent Document 1] Japanese Unexamined Patent Publication No. 2006-278574

[Patent Document 2] Japanese Unexamined Patent Publication No. 2004-10668

[Patent Document 3] Japanese Unexamined Patent Publication No. 2011-93213

### DISCLOSURE OF THE INVENTION

However, the technique disclosed in Patent Document 3 is still insufficient from a viewpoint of the balance between the electromagnetic wave shielding properties and the design properties. Further, the technique disclosed in Patent Document 3 is advantageous only to limited products and thus there is a problem in that the technique cannot be applied to products in various fields.

Here, the present invention has been made in consideration of the above-described problems and an object thereof is to provide an article with excellent electromagnetic wave shielding properties and thermal conductivity and at least one excellent characteristic from among abrasion resistance, waterproof properties, design properties, impact resistance, and flame retardance.

According to the present invention, there is provided an article including: a main body portion that is formed of a material composition containing a fiber filler and a resin and obtained using a paper-making method; and a functional layer that covers the main body portion.

Further, according to the present invention, there is provided a laminate including: a first layer that is formed of a first material composition containing a first fiber filler and a first resin which binds the first fiber fillers to each other and is obtained using a paper-making method; and a second layer that is formed of a second material composition containing a second fiber filler and a second resin which binds the second fiber fillers to each other and is obtained using a paper-making method, in which the first layer and the second layer are laminated with each other.

According to the present invention, it is possible to provide an article with excellent electromagnetic wave shielding properties and thermal conductivity and at least one excellent characteristic from among abrasion resistance, waterproof properties, design properties, impact resistance, and flame retardance.

### BRIEF DESCRIPTION OF THE DRAWINGS

The above-described object, another object, characteristics, and advantages will be described with reference to preferred embodiments described below and the accompanying drawings.

FIG. 1 is a cross-sectional view for describing an article according to an embodiment of the present invention.

FIG. 2 is a cross-sectional view for describing an article according to an embodiment of the present invention.

FIG. 3 is a cross-sectional view for describing an article according to an embodiment of the present invention.

FIG. 4 is a cross-sectional view for describing a method of producing a main body portion according to an embodiment of the present invention.

FIG. 5 is a cross-sectional view for describing a method of producing an article according to an embodiment of the present invention.

FIG. 6 is a cross-sectional view for describing a functional layer according to an embodiment of the present invention.

FIG. 7 is a cross-sectional view for describing a functional layer according to an embodiment of the present invention.

FIG. 8 is a cross-sectional view taken along a lamination direction of a laminate according to an embodiment of the present invention.

FIG. 9 is a view illustrating a process of producing a laminate.

FIG. 10 is a cross-sectional view taken along a lamination direction of a laminate according to an embodiment of the present invention.

FIG. 11 illustrates a laminate according to an embodiment of the present invention. FIG. 11(a) is a top view of the laminate and FIG. 11(b) is a cross-sectional view taken along the lamination direction of the laminate.

FIG. 12 is a view illustrating a process of producing a laminate according to an embodiment of the present invention.

### DESCRIPTION OF EMBODIMENTS

Hereinafter, embodiments of the present invention will be described with reference to the accompanying drawings. Further, in all drawings, the same reference numerals are denoted to the same constituent elements and the description thereof will not be repeated.

### First Embodiment

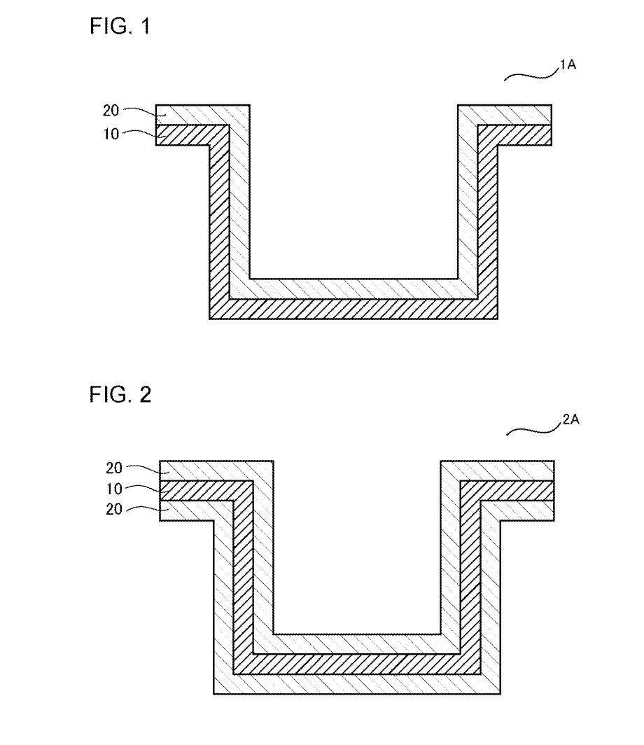

The outline of an article according to a first embodiment of the present invention will be described with reference to FIGS. 1 to 3.

Articles (1A, 2A, and 3A) according to the present embodiment include a main body portion 10 that is formed of a material composition containing a fiber filler 40 (A) (a fiber piece) and a resin 50 (B) and obtained by a paper-making method and a functional layer 20 covering the main body portion 10. With such a configuration, it is possible to obtain an article with excellent electromagnetic wave shielding properties and thermal conductivity and at least one excellent characteristic from among abrasion resistance, waterproof properties, design properties, impact resistance, and flame retardance.

In the present embodiment, the main body portion 10 is obtained using a paper-making method. The paper-making method indicates a technique of making paper which is one technique for producing paper. The main body portion 10 is obtained by applying a treatment to the material composition containing the fiber filler 40 (A) and the resin 50 (B) according to the paper-making method. The main body portion 10 with high strength can be obtained by employing the paper-making method. The reason for this is not necessarily clear, but it is considered that entanglement between the fiber fillers 40 (A) can be made as described above. Moreover, in the paper-making method, when the material composition is obtained, various materials other than the fiber filler 40 (A) and the resin 50 (B) may be combined and the combinations of materials are not restrictive. For this reason, additives other than the fiber filler 40 (A) and the resin 50 (B) can be suitably used according to the characteristics required for the article.

In addition, the fiber filler 40 (A) and the resin 50 (B) can be unsymmetrically arranged by producing the main body portion 10 according to the paper-making method. Accordingly, it is possible to respond to various characteristics required for a target article by suitably changing the blending amount of the fiber filler 40 (A) and the resin 50 (B), which is different from a method in the related art.

Further, the configuration of the main body portion 10 can vary according to the characteristics required for the article to be obtained. Examples of such a configuration, which is not particularly limited, include a configuration in which plural main body portions 10 obtained using material compositions with different compositions according to the paper-making method are laminated with each other and a configuration in which a part of the main body portion 10 is removed and then a part obtained using material compositions with different compositions according to the paper-making method is embedded in the removed region can be exemplified. In this manner, an article whose shape is adjusted into a preferable shape according to the use thereof can be obtained.

In the present embodiment, the functional layer 20 can employ various forms. Accordingly, it is possible to suitably change the configuration of the functional layer 20 according to the various characteristics required for the article. The article according to the present embodiment includes the main body portion 10 and the functional layer 20. As described above, it is possible to suitably change the forms of the main body portion 10 and the functional layer 20 respectively according to the various characteristics required for the article. That is, when the forms of the main body portion 10 and the functional layer 20 are respectively selected, combined, and then used, according to the present embodiment, it is possible to provide an article with various characteristics which are more excellent because of the synergistic effect thereof.

Hereinafter, the article according to the present embodiment will be described in detail.

FIGS. 1 to 3 are cross-sectional views for describing the article according to the present embodiment.

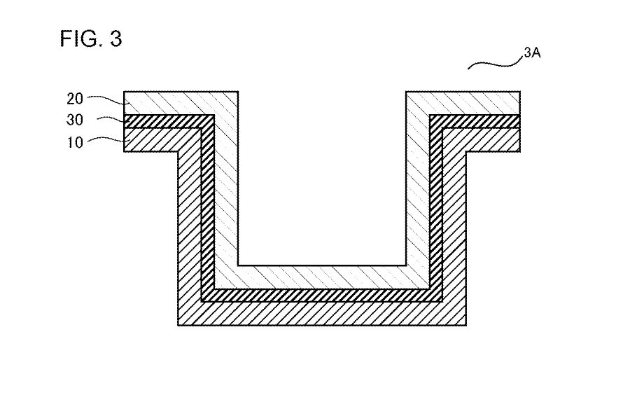

The articles (1A to 3A) according to the present embodiment include the main body portion 10 and the functional layer 20 as described above. Further, in such an article, the functional layer 20 may cover one surface of the main body portion 10 as illustrated in FIG. 1 or cover both surfaces thereof as illustrated in FIG. 2. An adhesive layer 30 may be included between the main body portion 10 and the functional layer 20 as illustrated in FIG. 3. Further, the main body portion 10 and the functional layer 20 may be reversely arranged with respect to the arrangement illustrated in FIGS. 1 to 3.

In regard to the article according to the present embodiment, the configuration of the main body portion 10 and a method of bonding the main body portion 10 and the functional layer 20 are the same in all the embodiments. Meanwhile, the functional layer 20 has various preferable forms as described below.

Moreover, as the functional layer 20, a layer which is formed of a material composition containing a fiber filler (fiber piece) and a resin and obtained using the paper-making method may be used. The layer obtained using the paper-making method can be produced with the same method as that of the main body portion 10. Further, the composition of the layer obtained using the paper-making method may be the same as or different from the composition of the main body portion described above.

First, the main body portion 10 (hereinafter, referred to as a “paper-making sheet 10”) will be described in detail.

(Paper-Making Sheet 10)

The paper-making sheet 10 is formed of a composite material composition. The composite material composition contains the fiber filler 40 (A) and the resin 50 (B) as constituent materials.

The kind of fiber filler 40 (A) varies according to the characteristics required for the paper-making sheet 10, and examples thereof include metal fibers; natural fibers such as wood fibers, cotton, hemp, and wool; regenerated fibers such as rayon fibers; semi-synthetic fibers such as cellulose fibers; synthetic fibers such as polyamide fibers, aramid fibers, polyimide fibers, polyvinyl alcohol fibers, polyester fibers, acrylic fibers, poly-p-phenylene benzoxazole fibers, polyethylene fibers, polypropylene fibers, polyacrylonitrile fibers, and ethylene vinyl alcohol fibers; carbon fibers; and inorganic fibers such as glass fibers and ceramic fibers.

These fibers may be used alone or in combination of two or more kinds thereof.

In a case where the paper-making sheet 10 having electromagnetic wave shielding performance or the paper-making sheet 10 having thermal conductivity performance is produced, it is preferable that the fiber filler 40 (A) contains metal fibers as a main component.

Further, in the case where the paper-making sheet 10 having thermal conductivity performance or electromagnetic wave shielding performance is produced, it is preferable that the fiber filler 40 (A) contains at least one of metal fibers or carbon fibers as a main component.

Further, in a case where the paper-making sheet 10 with high bending strength is produced, it is preferable that the fiber filler 40 (A) contains any of polyamide fibers, aramid fibers, polyimide fibers, and poly-p-phenylene benzoxazole fibers.

Further, in the case where the paper-making sheet 10 with high bending strength is produced, it is preferable that the fiber filler 40 (A) contains one of carbon fibers and inorganic fibers such as glass fibers and ceramic fibers.

The metal fibers may be metal fibers formed of a single metal element or synthetic fibers formed of plural metals, and it is preferable that metal elements constituting the metal fibers are one or more metals selected from a group consisting of aluminum, silver, copper, magnesium, iron, chromium, nickel, titanium, zinc, tin, molybdenum, and tungsten.

As the metal fibers in the present embodiment, for example, stainless fibers (manufactured by Nippon Seisen Co., Ltd. or Bekaert Japan Co., Ltd.), copper fibers, aluminum fibers, brass fibers, steel fibers, titanium fibers, and phosphor bronze fibers (manufactured by Kogi Corporation Co., Ltd.) can be obtained as commercially available products, but the metal fibers are not limited thereto. These metal fibers may be used alone or in combination of two or more kinds thereof. Among these, one or more of copper fibers, aluminum fibers, and brass fibers are preferable from a viewpoint of thermal conductivity and one or more of stainless fibers, copper fibers, and aluminum fibers are preferable from a viewpoint of electromagnetic wave shielding properties.

In addition, the metal fibers may be used as they are, but metal fibers to which a surface treatment is applied using a silane coupling agent, an aluminate coupling agent, or a titanate coupling agent according to the required characteristics or metal fibers to which a convergence agent treatment is applied in order to improve adhesiveness with the resin 50 and handleability thereof may be used.

Moreover, as fibers other than the metal fibers, for example, Kevlar (registered trademark) which is made from aramid fibers (manufactured by DU PONT-TORAY CO., LTD.); Technora (registered trademark) which is made from aramid fibers (manufactured by TEIJIN TECHNO PRODUCTS LIMITED); Vinylon which is made from polyvinyl alcohol fibers (manufactured by KURARAY CO., LTD.), nylon (registered trademark) which is made from poly-p-phenylene benzoxazole fibers (manufactured by TOYOBO CO., LTD.); glass fibers (manufactured by Nitto Boseki Co., Ltd.); or Denkaarusen which are made from alumina fibers (manufactured by DENKI KAGAKU KOGYO KABUSHIKI KAISYA) can be obtained as commercially available products, but the fibers are not limited thereto.

As the shape of the fiber filler 40, which is not particularly limited, the fiber filler having a shape in accordance with the required characteristics can be used, but it is preferable to use chopped strands in a case of improving strength characteristics such as the bending strength or impact resistance using fibers other than metal fibers. Further, in order to obtain an effect of improving the yield, fibers which are beaten by mechanical shear force using a beater or a homogenizer, or fibrillated fibers are preferable. Such fibers are preferable in terms of having a large fiber surface area, high physical capturing ability against the resin 50, and chemically acting easily with a polymer coagulant (described below).

Further, the content of the fiber filler 40 (A) according to the present embodiment is preferably equal to or more than 1% by mass and equal to or less than 90% by mass and particularly preferably properly used according to the required necessity. For example, it is preferable that the content thereof is equal to or more than 1% by mass and less than 30% by mass based on the content of the entire composite material composition in a case where the processability or lightweight properties of the resin 50 is required, it is preferable that the content thereof is equal to or more than 30% by mass and less than 60% by mass based on the content of the entire composite material composition in a case where the properties of the fiber filler 40 and the resin 50 need to be expressed in a highly balanced manner, and it is preferable that the content thereof is equal to or more than 30% by mass and equal to or less than 90% by mass based on the content of the entire composite material composition in a case where the properties of the fiber filler 40 such as thermal conductivity or rigidity are required. The performance of the fiber filler 40 can be expressed by adjusting the content of the fiber filler 40 (A) to be equal to or more than 1% by mass based on the content of the entire composite material composition. Further, degradation of the lightweight properties and the processability can be prevented by adjusting the content of the fiber filler 40 (A) to be equal to or less than 90% by mass based on the content of the entire composite material composition.

Further, the fiber length of the fiber filler 40 (A) according to the present embodiment, which is not particularly limited, is preferably properly used according to the required characteristics and, for example, the range thereof is preferably equal to or more than 500 μm and equal to or less than 10 mm. The characteristics of the fiber filler 40 (A) such as thermal conductivity, electromagnetic wave shielding properties, and rigidity can be expressed by adjusting the fiber length to be equal to or more than 500 μm.

Further, forming workability can be secured by adjusting the fiber length thereof to be equal to or more than 500 μm and equal to or less than 10 mm. The forming workability indicates surface smoothness and releasability of a formed article.

From viewpoints of expressing characteristics of the fiber filler 40 and securing the forming workability thereof, the fiber length of the fiber filler 40 is preferably equal to or more than 1 mm and more preferably equal to or more than 3 mm and equal to or less than 8 mm.

Further, the diameter of the fiber filler 40 (A) is preferably equal to or more than 1 μm and equal to or less than 100 μm and particularly preferably equal to or more than 5 μm and equal to or less than 80 μm. The rigidity of the composite material composition can be secured by adjusting the diameter thereof to be equal to or more than 1 μm and the forming workability can be secured by adjusting the diameter thereof to be equal to or less than 100 μm.

The length and the diameter of the fibers can be confirmed by, for example, observing the obtained paper-making sheet 8 with an electron microscope.

Further, the average fiber length and the average diameter thereof can be confirmed in the following manner.

The average fiber length thereof can be acquired by selecting one hundred fiber fillers 40 in total which are exposed to the surface of the paper-making sheet 10 and then calculating the average value thereof.

Further, the average fiber length and the average fiber diameter can be acquired by observing one hundred fiber fillers 40 extracted from the paper-making sheet 10 and then calculating the average value thereof. In addition, the fiber fillers 40 can be extracted by dissolving or melting the resin 50 of the paper-making sheet 10.

In the present invention, the fiber fillers 40 along with the resin 50 can be suitably fluidized at the time of forming and, as a result, the fiber fillers 40 in the obtained formed article are desirably uniformly dispersed. From a viewpoint of improving the fluidity, in the present invention, other fiber fillers having an average fiber length of less than 500 μm can be used in addition to the above-described fiber fillers 40.

Examples of other fiber fillers which can be used from a viewpoint of improving the fluidity include milled fibers and cut fibers. When milled fibers are used, the heat resistance and the dimensional stability of the paper-making sheet to be obtained can be improved.

The resin 50 (B) according to the present embodiment may be a thermoplastic resin or a thermosetting resin and is not particularly limited as long as the resin acts as a binder and can bind resins, and examples thereof include thermoplastic resins such as an acrylonitrile-styrene copolymer (AS) resin, an acrylonitrile-butadiene-styrene copolymer (ABS) resin, polycarbonate, polystyrene, polyvinyl chloride, a polyester resin, polyamide, a polyphenylene sulfide (PPS) resin, an acrylic resin, polyethylene, polypropylene, and a fluorine resin; and thermosetting resins such as a phenol resin, an epoxy resin, an unsaturated polyester resin, a melamine resin, and polyurethane. These resins can be suitably selected and then used according to the required characteristics. Further, these resins can be used alone or in combination of two or more kinds thereof. Among these, thermosetting resins are preferable from viewpoints of excellent mechanical strength and chemical resistance and thermoplastic resins are preferable from viewpoints that the formability is excellent and design properties such as transparency of resins are required.

The content of the resin 50 (B) in the composite material composition is preferably equal to or more than 5% by mass and equal to or less than 90% by mass based on the entire composite material composition.

In this case, it is preferable that the content of the resin (B) 50 is adjusted along with the adjustment of the content of the fiber fillers 40. In a case where the content of the fiber fillers 40 is equal to or more than 20% by mass and equal to or less than 80% by mass, it is preferable that the content of the resin 50(B) is equal to or more than 10% by mass and equal to or less than 70% by mass based on the entire composite material composition. In a case where the content of the fiber fillers 40 is equal to or more than 30% by mass and less than 60% by mass, it is preferable that the content of the resin 50 (B) is equal to or less than 60% by mass and equal to or more than 30% by mass.

In a case where the content of the fiber fillers 40 is equal to or more than 60% by mass and equal to or less than 90% by mass, it is preferable that the content of the resin 50 (B) is equal to or more than 5% by mass and equal to or less than 30% by mass.

It is preferable that the composite material composition contains a powdery substance having ion exchange ability (C).

It is preferable that the powdery substance having the ion exchange ability (C) according to the present embodiment is at least one kind of intercalation compound selected from clay minerals, scaly silica microparticles, hydrotalcites, fluorine taeniolite, and swellable synthetic mica.

The clay minerals are not particularly limited as long as the substance has the ion exchange ability and examples thereof include smectite, halloysite, kanemite, kenyaite, zirconium phosphate, and titanium phosphate. The hydrotalcites are not particularly limited as long as the substance has the ion exchange ability and examples thereof include hydrotalcite and a hydrotalcite-like substance. The fluorine taeniolite is not particularly limited as long as the substance has ion exchange ability and examples thereof include lithium type fluorine taeniolite and sodium type fluorine taeniolite. The swellable synthetic mica is not particularly limited as long as the substance has ion exchange ability and examples thereof include sodium type tetrasilicic fluorine mica and lithium type tetrasilicic fluorine mica. These intercalation compounds may be natural products or synthesized products and may be used alone or in combination of two or more kinds thereof. Among these, clay minerals are more preferable and smectite is still more preferable in terms that smectite exists in a form of a natural product or a synthetic product so that the range of selection is wide.

The smectite is not particularly limited as long as the substance has ion exchange ability and examples thereof include montmorillonite, beidellite, nontronite, saponite, hectorite, sauconite, and stevensite. Among these, any one or more kinds can be used. The montmorillonite is a hydrous silicate of aluminum, but may be bentonite that contains montmorillonite as a main component and minerals such as quartz, mica, feldspar, and zeolite. Ina case where these substances are used for an application that is concerned with coloration or impurities, synthetic smectite with fewer impurities is preferable.

Further, as the powdery substance having the ion exchange ability (C), for example, Kunipia (bentonite) and Sumecton SA (synthetic saponite) (manufactured by KUNIMINE INDUSTRIES CO., LTD.), SUNLOVELY (scaly silica microparticles) (manufactured by AGC Si-Tech Co., Ltd.), Somasif (swellable synthetic mica) and Lucentite (synthetic smectite) (manufactured by CO-OP CHEMICAL CO., LTD.), and Hydrotalcite STABIACE HT-1 (hydrotalcite) (manufactured by SAKAI CHEMICAL INDUSTRY CO., LTD.) can be obtained as commercially available products, but the powdery substance is not limited thereto.

The content of the powdery substance having the ion exchange ability (C) according to the present embodiment is preferably equal to or more than 0.1% by mass and equal to or less than 30% by mass and more preferably equal to or more than 2% by mass and equal to or less than 20% by mass based on the entire composite material composition. When the content thereof is in the above-described range, an effect of improving fixing properties of constituent materials with different properties each other such as the fiber filler 40 (A) and the resin 50 (B) can be obtained. In addition, it is preferable that the content of the powdery substance having the ion exchange ability (C) is adjusted along with the adjustment of the ratio of the fiber filler 40 (A) and the resin 50 (B) in the constituent material and the kind or the amount of a polymer coagulant.

It is preferable that the composite material composition contains the polymer coagulant (D).

The polymer coagulant, which will be described later, is used for aggregating the fiber filler 40 (A) and the resin 50 (B) in flocks. The polymer coagulant is not particularly limited by the ionicity or the like and a cationic polymer coagulant, an anionic polymer coagulant, a nonionic polymer coagulant, and an amphoteric polymer coagulant, or the like can be used. Examples of these coagulants include cationic polyacrylamide, anionic polyacrylamide, Hofmann polyacrylamide, Man Nick polyacrylamide, amphoteric copolymer polyacrylamide, cationic starch, amphoteric starch, and polyethylene oxide. These polymer coagulants may be used alone or in combination of two or more kinds thereof. Further, in regard to the polymer coagulant, the polymer structure, the molecular weight, or the amount of functional groups such as a hydroxyl group or an ionic group is can be used without particular limitation in accordance with the required characteristics.

Moreover, as the polymer coagulant, for example, polyethylene oxide (manufactured by Wako Pure Chemical Industries, Ltd., Kanto Chemical Industry Co., Ltd., or Sumitomo Seika Chemicals Co., Ltd.), Hari Fix which is cationic PAM, Hamaido B-15 which is anionic PAM, and Hamaido RB-300 which is amphoteric PAM (manufactured by Harima Chemicals, Inc.), and SC-5 which is cationic starch (manufactured by Sanwa Starch Co., Ltd.) can be obtained as commercially available products, but the polymer coagulant is not limited thereto.

Moreover, the added amount of the polymer coagulant, which is not particularly limited, is preferably equal to or more than 100 mass ppm and equal to or less than 1% by mass based on the weight of the constituent materials. The added amount thereof is more preferably equal to or more than 500 mass ppm and equal to or less than 0.5% by mass. In this manner, constituent materials can be suitably aggregated. When the added amount of the polymer coagulant is less than the lower limit thereof, the yield may be decreased. In addition, when the added amount thereof is more than the upper limit thereof, the aggregation becomes extremely strong so that dehydration or the like may occur.

For the composite material composition, for the purpose of improving characteristics, inorganic powder, metal powder, a stabilizer such as an antioxidant or a UV absorber, a release agent, a plasticizer, a flame retardant, a curing catalyst or a curing accelerator of a resin, a pigment, a paper strength enhancing agent such as a dry paper strength enhancing agent or a wet paper strength enhancing agent, a yield enhancing agent, a freeness enhancing agent, a size fixing agent, an anti-foaming agent, a sizing agent such as a rosin-based sizing agent for making acidic paper, a rosin-based sizing agent for making neutral paper, an alkyl ketene dimer sizing agent, an alkenyl succinic anhydride-based sizing agent, or a special modified rosin-based sizing agent, and a coagulant such as aluminum sulfate, aluminum chloride, or polyaluminum chloride and, for the purpose of adjusting production conditions and expressing required physical properties, various additives can be used, in addition to the powdery substance having the ion exchangeability (C), the fiber filler 40 (A), the resin 50 (B), and the polymer coagulant (D) described above.

Further, examples of the inorganic powder include oxides such as titanium oxide, alumina, silica, zirconia, and magnesium oxide; nitrides such as boron nitride, aluminum nitride, and silicon nitride; sulfates such as barium sulfate, iron sulfate, and copper sulfate; hydroxides such as aluminum hydroxide and magnesium hydroxide; minerals such as kaolinite, talc, natural mica, and synthetic mica; and carbides such as silicon carbide. These may be used as they are, but inorganic powder obtained by applying a surface treatment thereto using a silane coupling agent, an aluminate coupling agent, or a titanate coupling agent according to the required characteristics may be used.

In addition, according to the present embodiment, an article obtained by bonding the main body portion 10 and the functional layer 20 can be made into an article with electromagnetic wave shielding properties or the thermal conductivity which is well-balanced with other characteristics by producing the paper-making sheet 10 (main body portion 10). The reason thereof is not necessarily clear, but it is considered that the entanglement between the fiber fillers 40 (A) can be made because the fiber fillers 40 (A) can be blended without the article being broken, which is different from an article obtained using a method in the related art. In this manner, the orientation of the fiber fillers 40 (A) in the main body portion 10 is not determined so that the resin 50 (B) can be uniformly dispersed in the main body portion 10. Accordingly, it is considered that various characteristics of the article, which is obtained by coating the main body portion 10 with the functional layer 20, such as abrasion resistance, waterproof properties, design properties, impact resistance, and flame retardance as well as the electromagnetic wave shielding properties and the thermal conductivity can be improved.

(Method of Producing Paper-Making Sheet 10)

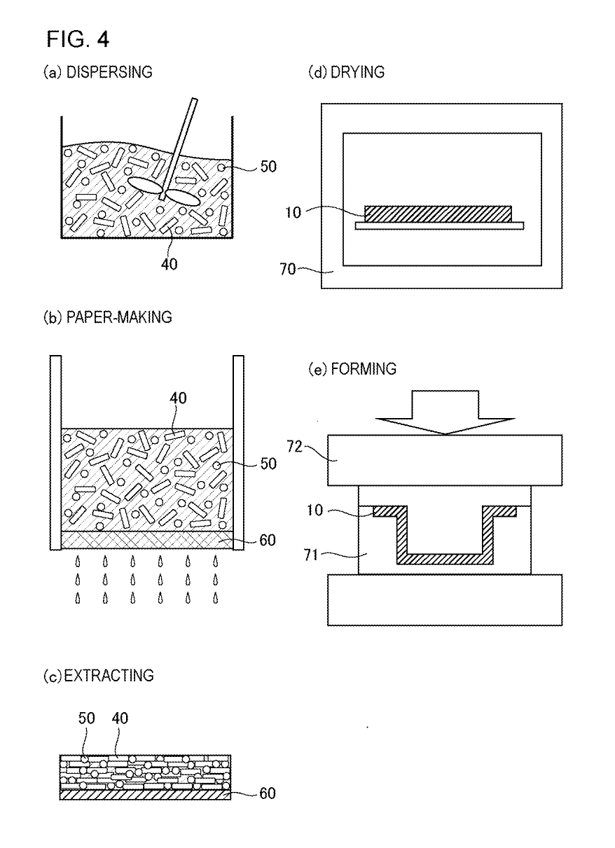

Next, a method of producing the paper-making sheet 10 will be described with reference to FIG. 4.

The paper-making sheet 10 can be produced according to a wet paper-making method and, for example, can be produced in the following manner.

Among the constituent materials of the above-described composite material composition, materials from which a polymer coagulant is removed are added to a solvent, stirred, and then dispersed (see FIG. 4(a)). As the method of dispersing the materials in the solvent, which is not particularly limited, a method of stirring using a disperser or a homogenizer can be exemplified.

In addition, in FIG. 4, the reference numeral 40 indicates the fiber filler and the reference numeral 50 indicates the resin.

The solvent is not particularly limited, but the boiling point thereof is preferably equal to or higher than 50° C. and equal to or lower than 200° C. from viewpoints that the solvent is unlikely to be volatilized during the process of dispersing the constituent materials of the composite material composition, the solvent is easily removed so that the solvent does not remain in the paper-making sheet 10, and an excessive amount of energy is needed for removing the solvent when the boiling point thereof is extremely high. Examples of such solvents include water; alcohols such as ethanol, 1-propanol, 1-butanol, and ethylene glycol; ketones such as acetone, methyl ethyl ketone, 2-heptanone, and cyclohexanone, esters such as ethyl acetate, butyl acetate, and methyl acetoacetate; and ethers such as tetrahydrofuran, isopropyl ether, dioxane, and furfural. These solvents can be used alone or in combination of two or more kinds thereof. Among these, water is particularly preferable in terms of the abundant amount of water to be supplied, low price, low environmental burden, high level of safety, and excellent handleability.

In addition, as the resin 50 (B) which is a constituent material of the composite material composition, a resin whose average particle diameter is equal to or less than 500 μm in a solid state can be used. Further, the resin 50 (B) may be in an emulsion state. It is more preferable that the average particle diameter of the resin 50 (B) is in the range of about 1 nm to 300 μm. In this manner, when a polymer coagulant is added, a state in which the resin 50 and the fiber fillers 40 are aggregated is easily formed and the yield is improved in the presence of a powdery substance having the ion exchange ability (C). Further, the average particle diameter of the resin 50 (B) can be acquired by measuring the 50% particle diameter on a mass basis as the average particle diameter using a laser diffraction particle diameter distribution measuring apparatus such as SALD-7000 (manufactured by Shimadzu Corporation).

Subsequently, a polymer coagulant is added. In a case where the composite material composition includes a powdery substance having the ion exchange ability (C), the state in which the resin 50 and the fiber fillers 40 are aggregated is easily formed and constituent materials in a solvent are more easily aggregated in flocks because of the powdery substance having the ion exchange ability (C).

Next, as illustrated in FIG. 4(b), the solvent and the aggregated constituent materials (aggregates) are added to a container whose bottom surface is formed of a mesh 60 and a solvent is discharged from the mesh 60. In this manner, the aggregates and the solvent are separated from each other (paper-making process).

Next, as illustrated in FIG. 4(c), sheet-like aggregates are extracted from the container illustrated in FIG. 4(b), put into a drying furnace 70, and are dried so that the solvent is further removed. Subsequently, aggregates are formed as illustrated in FIG. 4(d). In this manner, the paper-making sheet 10 can be obtained. As the forming method, press forming or the like can be exemplified. For example, as illustrated in FIG. 4(e), a sheet formed of aggregates is pressed by a press plate 71 and a hot plate 72 is arrange on the outer peripheral side of the press plate 71 and then heated. In this manner, the paper-making sheet 10 can be obtained.

In addition, in a case where a thermosetting resin is used as the resin 50 contained in the paper-making sheet 10, it is preferable that the thermosetting resin is in a semi-cured state in the paper-making sheet 10 produced in the above-described manner. When the thermosetting resin is in a semi-cured state, the functional layer 20 and the main body portion 10 (paper-making sheet 10) can be fixed to each other.

(Characteristics of Paper-Making Sheet 10)

The paper-making sheet 10 of the present embodiment is produced according to the above-described paper-making method. For this reason, most fiber fillers 40 are arranged such that the length direction of the fiber fillers 40 is along the in-plane direction of the sheet. Meanwhile, when the paper-making sheet 10 is seen in a plan view, the fiber fillers are randomly arranged in the plane and entangled with each other.

Accordingly, for example, in a case where the fiber fillers 40 are formed of thermal conductivity materials with high thermal conductivity, the thermal conductivity of the paper-making sheet 10 in the in-plane direction becomes extremely high.

In addition, the resin 50 is interposed between the fiber fillers 40 and plays a role of binding the fiber fillers 40 to each other.

As described above, in the paper-making sheet 10, the fiber fillers 40 (A) are moved to the mesh 60 side by its own weight when the solvent is discharged from the mesh 60 arranged on the bottom surface of the container as illustrated in FIG. 4(b). Depending on the content of the resin 50 (B) and the kind of fiber fillers 40 (A) in the paper-making sheet 10, the distance from the center position in the thickness of the fiber layer formed of the fiber fillers 40 (A) to one surface of the resin layer formed of the resin 50 (B) may be different from the distance from the center position thereof to another surface of the resin layer in the paper-making sheet 10.

In addition, depending on the content of the resin 50 (B) and the kind of fiber fillers 40 (A) in the paper-making sheet 10, plural voids may be formed in the inside of the fiber layer formed of the fiber fillers 40 (A). In this manner, the weight of the paper-making sheet 10 can be reduced.

Various characteristics of the paper-making sheet 10 can be exhibited by suitably setting the kind and the content of the fiber fillers 40 and the kind and the content of the resin 50.

For example, it is possible to make the paper-making sheet 10 with excellent electromagnetic wave shielding performance and thermal conductivity by using metal fibers, carbon fibers, or the like as fiber fillers 40 so that it is possible to protect the substrate from electromagnetic waves, and to conduct the heat from the substrate to other components. In addition, it is possible to make the paper-making sheet 10 with high thermal conductivity by using metal fibers or carbon fibers as fiber fillers 40.

Moreover, it is possible to make the paper-making sheet 10 with high rigidity by suitably selecting the fiber fillers 40.

(Functional Layer 20)

A layer produced using a resin composition is used as the functional layer 20 in the article according to the present embodiment. The functional layer 20 may use, for example, the following substances.

(I) a sheet containing a polycarbonate resin;

(II) a sheet formed of a resin composition containing a flame retardant;

(III) a sheet formed of a resin composition containing an aromatic polyether resin;

(IV) a waterproof resin layer; and

(V) a curable resin layer.

As described above, the functional layer 20 may have various forms. Hereinafter, respective sheets (layers) will be described.

(I) A Sheet Containing Polycarbonate Resin

First, a sheet containing a polycarbonate resin which is being used as the resin layer 20 will be described. When a sheet containing a polycarbonate resin is used as the functional layer 20, an article with excellent electromagnetic wave shielding properties and thermal conductivity and particularly excellent impact resistance can be obtained.

Examples of the resin composition containing a polycarbonate resin include a composition (1) containing a polycarbonate resin and a polyester resin, a composition (2) containing a polycarbonate resin and a polyester resin obtained by polycondensing a dicarboxylic acid-based component and a glycol component, and a composition (3) containing polycarbonate and a polymethyl methacrylate resin. As the polymethyl methacrylate resin, a composition which is a copolymer of a methyl methacrylate monomer and other copolymerizable ethylenically unsaturated monomers which are equal to or more than 50% by weight of methyl methacrylate can be exemplified, but the resin composition is not limited thereto.

The method of producing the functional layer 20 is not particularly limited and examples thereof include a calendering method, an extrusion method, a pressing method, and a casting method.

As a sheet containing a polycarbonate resin, “POLICA ACE” (manufactured by Sumitomo Bakelite Co., Ltd.) can be exemplified.

Hereinafter, as the sheet containing a polycarbonate resin, a case of using the composition (1) containing the polycarbonate resin and the polyester resin described above will be described as an example.

The polycarbonate resin can be obtained using a phosgene method of reacting various dihydroxy diaryl compounds with phosgene or a transesterification method of reacting a dihydroxy diaryl compound with carbonic acid ester such as diphenyl carbonate.

Examples of the dihydroxy diaryl compound include, in addition to bisphenol A, bis(hydroxyaryl)alkanes such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methylphenyl)propane, and 1,1-bis(4-hydroxy-3-tert-butylphenyl)propane; bis(hydroxyaryl)cycloalkanes such as 1,1-bis(4-hydroxyphenyl)cyclopentane, and 1,1-bis(4-hydroxyphenyl)cyclohexane; dihydroxy diaryl ethers such as 4,4′-dihydroxydiphenylether and 4,4′-dihydroxy-3,3′-dimethyldiphenylether; dihydroxy diaryl sulfides such as 4,4′-dihydroxydiphenylsulfide and 4,4′-dihydroxy-3,3′-dimethyldiphenylsulfide; dihydroxy diaryl sulfoxides such as 4,4′-dihydroxydiphenylsulfoxide and 4,4′-dihydroxy-3,3′-dimethyldiphenylsulfoxide; and dihydroxy diaryl sulfones such as 4,4′-dihydroxydiphenylsulfone and 4,4′-dihydroxy-3,3′-dimethyldiphenylsulfone. Further, these may be used alone or in combination of two or more kinds thereof.

In addition, when the carbonate resin is produced, a molecular weight controlling agent or a catalyst may be added as needed.

The content of the polycarbonate resin is equal to or more than 20 parts by weight and equal to or less than 80 parts by weight, preferably equal to or more than 30 parts by weight and equal to or less than 70 parts by weight, and more preferably equal to or more than 40 parts by weight and equal to or less than 60 parts by weight based on the total weight of the resin composition. When the content of the polycarbonate resin exceeds the above-described lower limit, the heat resistance thereof becomes excellent. Meanwhile, when the content of the polycarbonate resin is less than the above-described upper limit, the productivity becomes excellent from viewpoints of foaming at the time of forming, the heating time, and the shape reproducibility.

As the polyester resin, a resin obtained by polycondensing a dicarboxylic acid-based component and a glycol-based component can be exemplified. Examples of the dicarboxylic acid-based component include at least one kind selected from a group consisting of terephthalic acid and/or a derivative thereof. Examples of the terephthalic acid derivative, which is not particularly limited, include dimethyl terephthalic acid and diethyl terephthalic acid, and, among these, dimethyl terephthalic acid is preferable. Examples of the glycol-based component include 1,4-cyclohexanedimethanol.

It is preferable that the glycol-based component contains equal to or more than 40% by mole of 1,4-cyclohexanedimethanol. In this manner, the functional layer 20 with transparency can be obtained. The content of 1,4-cyclohexanedimethanol in the glycol-based component is preferably equal to or more than 50% by mole. In addition, 1,4-cyclohexanedimethanol may be a cis type or a trans type. Further, examples of glycol-based condensation components used in combination with 1,4-cyclohexanedimethanol, which are not particularly limited, include ethylene glycol and propylene glycol. Among these, ethylene glycol is preferable from viewpoints of the balance between the physical properties and the low price due to mass industrial production. Needless to say, 100% 1,4-cyclohexanedimethanol may be used as a glycol-based component.

The content of the polyester resin contained in the resin composition is, for example, equal to or more than 20 parts by weight and equal to or more than 80 parts by weight, preferably equal to or more than 30 parts by weight and equal to or less than 70 parts by weight, and more preferably equal to or more than 40 parts by weight and equal to or less than 60 parts by weight based on the total weight of the resin composition. When the content of the polyester resin is less than the upper limit thereof, the heat resistance becomes excellent. Meanwhile, when the content of the polyester resin exceeds the lower limit thereof, the productivity thereof becomes excellent from viewpoints of foaming at the time of forming, the heating time, and the shape reproducibility.

Preferably, the resin composition contains a phosphate compound (A), and/or one or more kinds of compounds (B) from among a phosphite compound, and a phosphonite compound. When the resin composition contains such compounds, the functional layer 20 to be obtained has excellent forming stability and heat discoloration resistance.

Examples of the phosphate compound (A) include a phosphate compound represented by the following general formula (1) or (2) and an alkyl acid phosphate compound which is a mixture of compounds represented by the following general formulae (1) and (2).

(R¹—O)₂—P(O)—OH (1)

(R²—O)—P(O)—(OH)₂ (2)

In the general formula (1) or (2), R¹ and R² represent an alkyl group having 4 to 20 carbon atoms.

In the above-described alkyl acid phosphate compound, examples of the alkyl group having 4 to 20 carbon atoms which is represented by R¹ and R² include butyl, octyl, dodecyl, tridecyl, isotridecyl, tetradecyl, hexadecyl, octadecyl, and eicosyl having a linear or branched structure, and these alkyl groups may be used alone or a mixture of plural alkyl groups.

The mechanism of preventing coloration of a resin at the time of forming using dialkyl diacid phosphate represented by the general formula (1) or monoalkyl acid phosphate represented by the general formula (2) is considered to work by forming a complex by combining a metal catalyst residue, particularly, a titanium-based metal catalyst residue, and the phosphate compounds and then deactivating the catalyst residues. Further, between these monoalkyl acid phosphate is more effective in terms that the effects thereof are exhibited even though the amount thereof is relatively small and monoalkyl acid phosphate is stabilized at the time of forming according to an extrusion method. The reason for this is not necessarily clear, but it is considered that a hydroxyl group bonded to phosphorous atoms which are contained in a phosphate compound acts in preventing coloration.

In addition, the alkyl acid phosphate compound can be easily synthesized according to a known method such as a method of hydrolyzing corresponding trialkyl phosphate; a method of reacting phosphorous oxychloride with corresponding alkanol and then hydrolyzing the resultant; or a method of reacting phosphorous pentoxide with corresponding alkanol.

Moreover, a long chain alkyl acid phosphate compound synthesized using the method of reacting phosphorous pentoxide with corresponding alkanol can be easily obtained as a mixture of dialkyl diacid phosphate represented by the general formula (1) and monoalkyl acid phosphate represented by the general formula (2) and an operation of separation from the mixture is complicated.

Since the monoalkyl acid phosphate compound and the dialkyl diacid phosphate compound sufficiently exhibit the effect of preventing coloration of a resin at the time of forming even when added at the same time, in the present embodiment, the mixture of these monoalkyl acid phosphate and dialkyl acid phosphate can be used as it is.

The content of the alkyl acid phosphate compound is equal to or more than 0.005 parts by weight and equal to or less than 0.15 parts by weight and more preferably equal to or more than 0.01 parts by weight and equal to or less than 0.1 parts by weight based on 100 parts by weight of the polycarbonate resin and the polyester resin in total. The coloration of the resin at the time of forming can be more effectively prevented when the content thereof exceeds the lower limit thereof and the compound becomes excellent when the content thereof is less than the lower limit thereof from viewpoints of stability at the time of forming and heat discoloration resistance.

Next, one or more kinds of compounds (B) from among the phosphite compound and the phosphonite compound will be described.

As the phosphite compound, phosphite ester esterified by phenol in which at least one ester in the phosphite ester has at least one phenol and/or an alkyl group having 1 to 25 carbon atoms can be exemplified.

Examples of the phosphite compound, which is not particularly limited, include trioctyl phosphite, tridecyl phosphite, trilauryl phosphite, tristearyl phosphite, triisooctyl phosphite, tris(nonylphenyl)phosphite, tris(2,4-dinonylphenyl)phosphite, tris(2,4-di-tert-butylphenyl)phosphite, triphenyl phosphite, tris(octylphenyl)phosphite, diphenyl isooctyl phosphite, diphenyl isodecyl phosphite, octyl diphenyl phosphite, dilauryl phenyl phosphite, diisodecyl phenyl phosphite, bis(nonylphenyl)phenyl phosphite, diisooctyl phenyl phosphite, diisodecyl pentaerythritol diphosphite, dilauryl pentaerythritol diphosphate, distearyl pentaerythritol diphosphate, (phenyl)(1,3-propanediol)phosphite, (4-methylphenyl)(1,3-propanediol)phosphite, (2,6-dimethylphenyl)(1,3-propanediol)phosphite, (4-tert-butylphenyl)(1,3-propanediol)phosphite, (2,4-di-tert-butylphenyl)(1,3-propanediol)phosphite, (2,6-di-tert-butylphenyl)(1,3-propanediol)phosphite, (2,6-di-tert-butyl-4-methylphenyl)(1,3-propanediol)phosphite, (phenyl)(1,2-ethanediol)phosphite, (4-methylphenyl)(1,2-ethanediol)phosphite, (2,6-dimethylphenyl)(1,2-ethanediol)phosphite, (4-tert-butylphenyl)(1,2-ethanediol)phosphite, (2,4-di-tert-butylphenyl)(1,2-ethanediol)phosphite, (2,6-di-tert-butylphenyl)(1,2-ethanediol)phosphite, (2,6-di-tert-butyl-4-methylphenyl)(1,2-ethanediol)phosphite, (2,6-di-tert-butyl-4-methylphenyl)(1,4-butanediol)phosphite or the like; diphenyl pentaerythritol diphosphite, bis(2-methylphenyl)pentaerythritol diphosphite, bis(3-methylphenyl)pentaerythritol diphosphite, bis(4-methylphenyl)pentaerythritol diphosphite, bis(2,4-dimethylphenyl)pentaerythritol diphosphite, bis(2,6-dimethylphenyl)pentaerythritol diphosphite, bis(2,3,6-trimethylphenyl)pentaerythritol diphosphite, bis(2-tert-butylphenyl)pentaerythritol diphosphite, bis(3-tert-butylphenyl)pentaerythritol diphosphite, bis(4-tert-butylphenyl)pentaerythritol diphosphite, bis(2,4-di-tert-butylphenyl)pentaerythritol diphosphite, bis(2,6-di-tert-butylphenyl)pentaerythritol diphosphite, bis(2,6-di-tert-butyl-4-methylphenyl)pentaerythritol diphosphite, bis(2,6-di-tert-butyl-4-ethylphenyl)pentaerythritol diphosphite, bis(nonylphenyl)pentaerythritol diphosphite, bis(biphenyl)pentaerythritol diphosphite, and dinaphthyl pentaerythritol diphosphate or the like.

Examples of the phosphorous acid ester compound include, for example, tris(2,4-di-tert-butylphenyl)phosphite, bis(2,4-di-tert-butylphenyl)pentaerythritol diphosphite, bis(2,6-di-tert-butyl-4-methylphenyl)pentaerythritol diphosphite, and distearyl pentaerythritol diphosphite. Among these, tris(2,4-di-tert-butylphenyl)phosphite and bis(2,6-di-tert-butyl-4-methylphenyl)pentaerythritol diphosphite are preferable.

As the phosphonite compound, a phosphonite compound represented by the following formula (3) can be exemplified.

(R₄O)₂—P—R₃—R₃—P—(OR₄)₂ (3)

In the general formula (3), R₃ represents a phenyl group or a phenylene group and R₄ represents a phenyl group, an alkyl group having 1 to 6 carbon atoms, or a phenyl derivative having 7 to 15 carbon atoms. As the phenyl derivative, a phenyl group substituted with an alkyl group having 1 to 9 carbon atoms can be exemplified.

Examples of the phosphonite compound, which is not particularly limited, include tetrakis(2,4-di-tert-butyl-phenyl)-4,4′-biphenylenediphosphonite, tetrakis(2,5-di-tert-butyl-phenyl)-4,4′-biphenylenediphosphonite, tetrakis(2,3,4-trimethylphenyl)-4,4′-biphenylenediphosphonite, tetrakis(2,3-dimethyl-5-ethyl-phenyl)-4,4′-biphenylenediphosphonite, tetrakis(2,4-di-tert-butyl-5-methyl-phenyl)-4,4′-biphenylenediphosphonite, tetrakis(2,6-di-tert-butyl-5-ethylphenyl)-4,4′-biphenylenediphosphonite, tetrakis(2,3,4-tri-butylphenyl)-4-4′-biphenylenediphosphonite, and tetrakis(2,4,6-tri-tert-butylphenyl)-4,4′-biphenylenediphosphonite.

Among these, as the phosphonite compound, a 4,4′-biphenylenediphosphonite compound of tetrakis(2,4-di-tert-butyl-phenyl)-4,4′-biphenylenediphosphonite or the like is preferable.

Ina case where the phosphate compound (A) and at least one kind of compound (B) from among the above-described phosphite compound or the phosphonite compound are used in combination, the ratio [A/B] of the content of these is equal to or more than 0.01 and equal to or less than 1 and more preferably equal to or more than 0.03 and equal to or less than 0.5. When the ratio [A/B] of the content of the phosphate compound (A) to the compound (B) is in the above-described range, the effects are markedly exhibited from viewpoints of preventing coloration and preventing heat discoloration resistance. Further, heat discoloration resistance becomes excellent from a viewpoint of preventing coloration when the ratio [A/B] of the content exceeds the lower limit and heat discoloration resistance becomes excellent from a viewpoint of stability at the time of forming when the ratio [A/B] of the content is less than the upper limit thereof.

Further, the resin composition may contain a UV absorber.

Examples of the UV absorber, which is not particularly limited, include benzophenones, benzotriazoles, benzoates, phenyl salicylates, crotonic acids, malonates, organoacrylates, hindered amines, hindered phenols, and triazines. These UV absorbers may be used alone or in combination of plural kinds thereof. Further, these UV absorbers may be uniformly added to the resin composition, form a layer with high concentration on the surface layer as a multi-layer structure, or combine those layers.

In addition, the resin composition may contain a flame retardant.

Examples of the flame retardant, which is not particularly limited, include a bromine-based flame retardant, a phosphorous-based flame retardant, a chlorine-based flame retardant, an inorganic flame retardant, a nitrogen-based flame retardant, and a silicone-based flame retardant.

The blending amount of the flame retardant is equal to or more than 0.01 parts by weight to equal to or less than 5 parts by weight, preferably equal to or more than 0.1 parts by weight and equal to or less than 4 parts by weight, still more preferably equal to or more than 1 part by weight and equal to or less than 3 parts by weight based on the total content of the resin composition. It becomes excellent from a viewpoint of an effect of improving the flame retardance when the content of the flame retardant exceeds than the lower limit thereof and becomes excellent when the content thereof is less than the upper limit thereof from a viewpoint of improving the appearance of a plate at the time of production according to the extrusion method or the like.

Moreover, the resin composition may contain additives generally being used, for example, a stabilizer, a lubricant, a processing aid, a pigment, an antistatic agent, an antioxidant, a neutralizing agent, and a dispersant as needed.

The method of producing a sheet which is the functional layer 20 with the above-described resin composition is not particularly limited, but, for example, thermoforming such as vacuum forming, pressure forming, vacuum pressure forming, or press forming can be used.

(II) Sheet Formed Using Resin Composition that Contains Flame Retardant

Next, a sheet which is being used as the functional layer 20 and formed using a resin composition that contains a flame retardant will be described. When the sheet is used as the functional layer 20, it is possible to obtain an article with excellent electromagnetic wave shielding properties and thermal conductivity and particularly excellent flame retardance.

As the resin composition containing a flame retardant, a composition that contains a resin having a polycarbonate resin or a polyolefin resin and a flame retardant can be exemplified.

In addition, examples of the method of producing the functional layer 20, which is not particularly limited, include a calendering method, an extrusion method, a pressing method, and a casting method.

As the sheet formed using the resin composition that contains a flame retardant, “SUNLOID Eco-sheet Polycarbonate” (manufactured by Sumitomo Bakelite Co., Ltd.) can be exemplified.

Hereinafter, the resin composition containing a flame retardant will be described in detail.

(Resin)

A resin used for the above-described resin composition is a polycarbonate resin or a polyolefin resin.

The polycarbonate resin, which is not particularly limited, can be obtained using a phosgene method of reacting various dihydroxy diaryl compounds with phosgene or a transesterification method of reacting a dihydroxy diaryl compound with carbonic acid ester such as diphenyl carbonate.

Examples of the dihydroxy diaryl compound, which is not particularly limited, include, in addition to bisphenol A, bis(hydroxyaryl)alkanes such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methylphenyl)propane, and 1,1-bis(4-hydroxy-3-tert-butylphenyl)propane; bis(hydroxyaryl)cycloalkanes such as 1,1-bis(4-hydroxyphenyl)cyclopentane, and 1,1-bis(4-hydroxyphenyl)cyclohexane; dihydroxy diaryl diethers such as 4,4′-dihydroxydiphenylether and 4,4′-dihydroxy-3,3′-dimethyldiphenylether; dihydroxy diaryl sulfides such as 4,4′-dihydroxydiphenylsulfide and 4,4′-dihydroxy-3,3′-dimethyldiphenylsulfide; dihydroxy diaryl sulfoxides such as 4,4′-dihydroxydiphenylsulfoxide and 4,4′-dihydroxy-3,3′-dimethyldiphenylsulfoxide; dihydroxy diaryl sulfones such as 4,4′-dihydroxydiphenylsulfone and 4,4′-dihydroxy-3,3′-dimethyldiphenylsulfone. Further, these may be used alone or in combination of two or more kinds thereof.

The weight average molecular weight of the polycarbonate resin, which is not particularly limited, for example, is equal to or more than 1.2×10⁴ and equal to or less than 3.5×10⁴, preferably 1.5×10⁴ to 3.0×10⁴, and still more preferably 1.8×10⁴ to 2.8×10⁴ from viewpoints of flame retardance, formability, and mold adhesiveness. Further, the weight average molecular weight of the polycarbonate resin can be calculated in terms of polystyrene using gel permeation chromatography.

In addition, when the polycarbonate resin is produced, a molecular weight controlling agent or a catalyst may be added as needed.

Examples of the polyolefin resin, which is not particularly limited, include a high-density polyethylene resin, a polypropylene resin, a polybutene resin, an ethylene-(meth)acrylic acid copolymer, an ethylene-methyl(meth)acrylate copolymer, an ethylene-ethyl(meth)acrylate copolymer, an ethylene-vinyl acetate copolymer, maleic anhydride-modified polyethylene, carboxylic acid-modified polyethylene, an ethylene-propylene copolymer, and an ethylene-propylene-diene copolymer. These resins can be used alone or a combination of two or more kinds thereof.

In addition, the polycarbonate resin and the polyolefin resin can be used in combination. It is preferable to contain the poly carbonate resin from a viewpoint of heat resistance and bending processability.

Moreover, in addition to the above-described resins, a polyester resin, a polyethylene terephthalate resin, a polyacrylate resin, a polybutylene terephthalate resin, a polylactic acid, a styrene-based copolymer, a polyacetal resin, a polyamide resin, a polyphenylene ether resin, a polyphenylene sulfide resin, a polymethylmethacrylate resin, or a cellulose ester resin may be combined together.

(Flame Retardant)

Examples of the flame retardant according to the present embodiment, which is not particularly limited, include a bromine-based flame retardant, a phosphorous-based flame retardant, a chlorine-based flame retardant, an inorganic flame retardant, a nitrogen-based flame retardant, a silicone-based flame retardant, and a flame retardant formed of a nitrogen-containing compound. Among these, the functional layer 20 with excellent flame retardance, heat resistance, forming workability, and mold adhesiveness can be obtained when a flame retardant formed of a nitrogen-containing compound is used. Hereinafter, a flame retardant formed of a nitrogen-containing compound will be described.

As the nitrogen-containing compound, a compound having a triazine skeleton is preferable from a viewpoint of further improving the above-described effects.

Examples of the compound having a triazine skeleton, which is not particularly limited, include melamine; melamine derivatives such as butyl melamine, trimethylol melamine, hexamethylol melamine, hexamethoxy methyl melamine, or melamine phosphate; cyanuric acid; a cyanuric acid derivative such as methyl cyanurate, diethyl cyanurate, trimethyl cyanurate, or triethyl cyanurate; isocyanuric acid; an isocyanuric acid derivative such as methyl isocyanurate, N,N′-diethyl isocyanurate, trismethyl isocyanurate, trisethyl isocyanurate, bis(2-carboxyethyl)isocyanurate, 1,3,5-tris(2-carboxyethyl)isocyanurate, or tris(2,3-epoxypropyl)isocyanurate; melamine cyanurate; and melamine isocyanurate. These compounds can be used alone or in combination of two or more kinds thereof.

As the compound having a triazine ring skeleton, it is preferable to use one or more kinds of melamine-based compounds selected from a group consisting of melamine, melamine cyanurate, melamine isocyanurate, and a derivative thereof and particularly preferable to use melamine cyanurate. In this manner, the flame retardance and the heat resistance of the functional layer 20 to be obtained and the forming workability and the mold adhesiveness of the flame-retardant resin composition become excellent in a well-balanced manner.

The blending amount of the flame retardant is in the range of 0.1 parts by weight to 30 parts by weight, preferably in the range of 1 part by weight to 20 parts by weight, and still more preferably in the range of 2 parts by weight to 10 parts by weight based on the 100 parts by weight of the resin.

The functional layer 20 with excellent flame retardance can be obtained when the blending amount of the flame retardant exceeds the lower limit thereof and the functional layer 20 with excellent forming workability and mold adhesiveness can be obtained when the blending amount thereof is less than the upper limit thereof. That is, when the blending amount of the flame retardant is in the above-described range, the functional layer 20 with more excellent flame retardance, heat resistance, forming workability, and mold adhesiveness can be obtained.

Further, a decrease in the heat resistance of the functional layer 20 to be obtained is suppressed by adding a large amount of flame retardant formed of a nitrogen-containing compound.

The flame retardant may be particulate. The average particle diameter of particles is in the range of 0.01 μm to 30 μm, preferably in the range of 0.5 μm to 20 μm, and still more preferably in the range of 1 μm to 10 μm. When a flame retardant whose average particle diameter is in the above-described range is used, the functional layer 20 with excellent forming workability and mold adhesiveness can be obtained. In addition, the average particle diameter can be measured using a laser diffraction and scattering method.

The above-described resin composition may contain additives generally being used if necessary, for example, a stabilizer, a lubricant, a processing aid, a pigment, an antistatic agent, an antioxidant, a neutralizing agent, a UV absorber, a dispersant, and a thickener.

Preferably, the above-described resin composition contains 0.1 parts by weight to 30 parts by weight of melamine cyanurate, preferably 1 part by weight to 20 parts by weight thereof, and more preferably 2 parts by weight to 10 parts by weight thereof based on 100 parts by weight of the polycarbonate resin.

It is preferable that the polycarbonate resin and the melamine cyanurate satisfy all of the following physical properties. In addition, these numerical ranges can be arbitrarily combined.

Viscosity average molecular weight of polycarbonate resin: 1.2×10⁴ to 3.5×10⁴, preferably 1.5×10⁴ to 3.0×10⁴, and more preferably 1.8×10⁴ to 2.8×10⁴.

Average particle diameter of melamine cyanurate: 0.01 μm to 30 μm, preferably 0.5 μm to 20 μm, and more preferably 1 μm to 10 μm.

(III) Sheet Formed of Resin Composition that Contains Aromatic Polyether Resin

Hereinafter, a sheet formed of a resin composition containing an aromatic polyether resin which is being used as the functional layer 20 will be described.

When a sheet formed of a resin composition with an aromatic polyether resin is used as the functional layer 20, an article with excellent electromagnetic wave shielding properties and thermal conductivity and particularly excellent abrasion resistance can be obtained.

Examples of the resin composition containing an aromatic polyether resin include a composition (1) formed of at least two or more kinds of resins selected from among an aromatic polyether ketone resin, a polysulfone resin, and a polyether imide resin and a composition (2) that contains an aromatic polyether ketone resin with three or two layers, but the resin composition is not limited thereto.

As the sheet formed of a resin composition containing an aromatic polyether resin, “SUMILITE” (manufactured by Sumitomo Bakelite Co., Ltd.) can be exemplified and, among the products, “SUMILITE FS1100” or the like is preferably used.

Hereinafter, a resin composition constituting the functional layer 20 which is formed from a composition (1) formed of at least two or more kinds of resins selected from among an aromatic polyether ketone resin, a polysulfone resin, and a polyether imide resin will be described as an example.

The aromatic polyether ketone resin, which is not particularly limited, is a thermoplastic resin having a repeating unit represented by the following chemical formula (1) or (2). In addition, as a substance having a structure of the chemical formula (1), PEEK (trade name, manufactured by VICTREX, Inc.) can be exemplified.

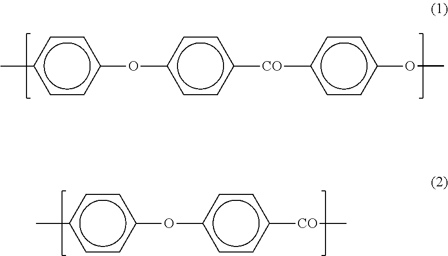

In addition, the following repeating units can be included other than the repeating units represented by the chemical formulae (1) and (2).

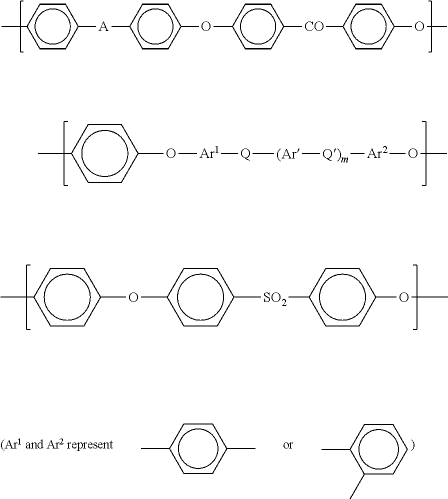

(In the formula, A represents a direct bond, O, S, SO₂, CO, or a divalent hydrocarbon group; Q and Q′ each represent SO₂ or CO; Ar′ represents a divalent aromatic group; and m represents 0, 1, 2, or 3.)

As the polysulfone resin, which is not particularly limited, a polysulfone resin having a repeating unit represented by any of the chemical formulae (3) to (10) can be exemplified.

As the polyetherimide resin, which is not particularly limited, a resin having a repeating unit represented by the following chemical formula (11) or (12) can be exemplified. Further, as a resin having a structure of the following chemical formula (11), ULTEM (trade name, manufactured by General Electric Company) or the like can be exemplified.

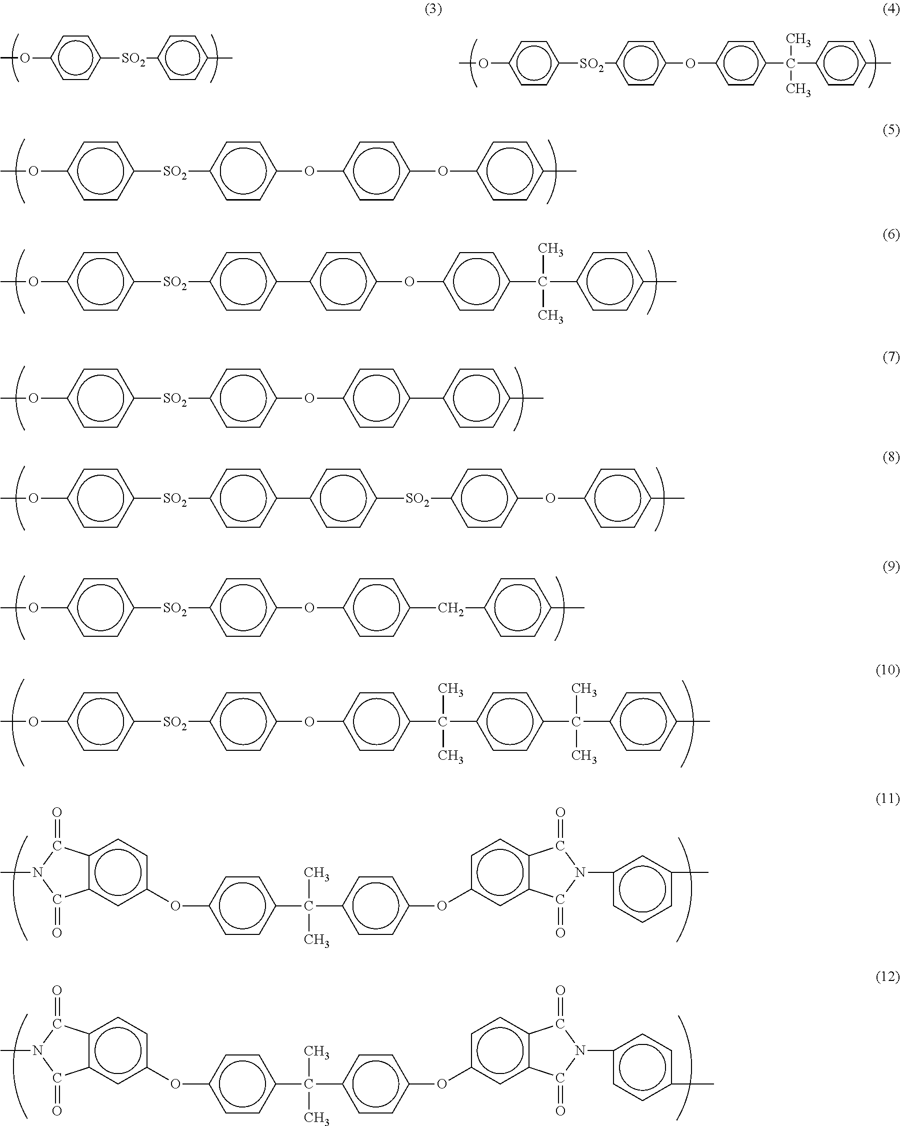

It is preferable that the resin composition contains a plate-like filler. The amount of the plate-like filler to be added is in the range of 5 parts by weight to 50 parts by weight and preferably in the range of 10 parts by weight to 40 parts by weight based on 100 parts by weight of the resin component. When the amount of the plate-like filler to be added exceeds the lower limit with respect to the resin component, the functional layer 20 which is excellent from viewpoints of the productivity, the cost, the heat resistance, the chemical resistance, and dimensional stability of the resin composition to be obtained can be obtained. Meanwhile, when the amount of the plate-like filler to be added is less than the upper limit with respect to the resin component, the functional layer 20 which is excellent from a viewpoint of the forming workability of the resin composition can be obtained.

The average particle diameter of the plate-like filler is preferably in the range of 0.1 μm to 20 μm, more preferably in the range of 1 μm to 10 μm, and still more preferably in the range of 2 μm to 8 μm.

When the average particle diameter of the plate-like filler exceeds the lower limit thereof, the functional layer 20 with excellent fluidity at the time of melting processing from viewpoints of improving the productivity, the cost, the heat resistance, the chemical resistance, and dimensional stability of the resin can be obtained.

When the average particle diameter of the plate-like filler is less than the upper limit thereof, the functional layer 20 becomes excellent from viewpoints of smoothness of the surface thereof and the fluidity at the time of melting processing.

When the plate-like filler is used, the dimensional stability of a sheet to be obtained can be drastically improved. Since the plate-like filler has an effect of suppressing a resin-specific linear expansion behavior in a temperature range of the use environment and an effect of suppressing the softening of a resin, the mechanical characteristics can be improved.

Moreover, according to the plate-like filler, since the dispersibility with respect to a base material resin is excellent and the filler can be uniformly dispersed in a resin, it is possible to uniformly provide excellent characteristics for the entire resin composition.

It is preferable that the plate-like filler has an aspect ratio of equal to or more than 10. In this case, the aspect ratio of the plate-like filler is expressed by the average particle diameter/the average thickness of the plate-like filler. When the aspect ratio of the plate-like filler is equal to or more than 10, since an effect of reducing the linear expansion coefficient can be effectively expressed, the excellent functional layer 20 can be obtained.

The plate-like filler is not particularly limited, but a filler having silicon oxide, alumina oxide, and magnesium oxide as main components can be used.

In the resin composition, it is preferable that the resin and the plate-like filler are uniformly mixed. Further, the resin composition may contain fiber-reinforcements (glass fibers, carbon fibers, potassium titanate fibers, ceramic fibers, aramid fibers, boron fibers, and the like), particulate or scaly-reinforcements (calcium carbonate, clay, talc, mica, graphite carbon, molybdenum disulfide, and the like), conductivity enhancing materials (carbon, zinc oxide, titanium oxide, and the like), thermal conductivity enhancing materials (powdery metal oxide and the like), an antioxidant, a heat stabilizer, an antistatic agent, a UV absorber, a lubricant, a release agent, a dye, a pigment, and other thermoplastic resins (a polyamide resin, a polycarbonate resin, a polyacetal resin, a PET resin, a PBT resin, a polyarylate resin, a polyphenylene sulfide resin, a polyether sulfone resin, a polyimide resin, a fluorine resin, a polyethernitrile resin, a liquid crystal polymer resin, and the like), and thermosetting resins (a phenol resin, an epoxy resin, a polyimide resin, a silicon resin, a polyamideimide resin, and the like). Further, the surface treatment may be carried out with respect to respective filler materials.

Moreover, methods of adding, mixing, and kneading the resin described above and the plate-like filler are not particularly limited and various mixing and kneading means are used. For example, the resin and the plate-like filler may be respectively supplied to a melt extruder and then mixed to each other or only powder raw materials are subjected to dry preliminary kneading using a mixer such as a Henschel mixer, a ball mixer, a blender, a tumbler or the like and then melted and kneaded in the melt extruder. As a forming method, an appropriate forming method can be applied to a resin serving as a base material. For example, various forming methods such as injection forming, melt extrusion forming, cast forming, compression forming, sinter forming, and powder coating can be exemplified.

The resin composition is made into a film or a sheet according to the melt extrusion forming, but the extrusion method or the receiving method is not particularly limited.

As the method of producing the functional layer 20 formed of a resin composition described above, a method of receiving the resin composition immediately after melt extrusion and cooling and solidifying the resin composition using a cooling roll. By making the surface of the cooling roll smooth, the smoothness of the surface of the roll can be transferred to the surface of the sheet when the melted resin is solidified. In addition, the surface of the cooling roll is subjected to matt finish and a surface of the sheet with predetermined surface roughness can be obtained.

In order to obtain the functional layer 20 with excellent surface smoothness, it is necessary for foreign matters not to be mixed thereinto. When the resin composition is subjected to melt extrusion and then processed into a sheet shape, kneading foreign matters or the like can be removed by filtering the melt resin composition. The kind or condition of the foreign matter removing filter used for filtration is not particularly limited.

(IV) Waterproof Resin Layer

Hereinafter, a waterproof resin layer used as the functional layer 20 will be described. When a waterproof resin layer is used as the functional layer 20, an article with excellent electromagnetic wave shielding properties and thermal conductivity and particularly excellent waterproof properties can be obtained.

Further, examples of the waterproof resin layer according to the present embodiment include a layer (1) formed of a waterproof layer on the surface side, which is formed of a synthetic resin, and an insulating layer and a layer (2) obtained by coating, laminating, and integrating a waterproof resin layer on the surface side and a waterproof resin layer on the rear surface side, but the waterproof resin layer is not limited thereto.

As a sheet containing a waterproof resin layer, for example, “SUNLOID DN sheet” (manufactured by Sumitomo Bakelite Co., Ltd.) can be exemplified.

Hereinafter, in regard to the resin composition constituting the waterproof resin layer, the layer (1) formed of a waterproof layer on the surface side, which is formed of a synthetic resin, and an insulating layer will be described as an example.

FIG. 6 is a cross-sectional view of a waterproof resin layer according to the present embodiment.

A waterproof resin layer 1 includes a waterproof layer on a skeleton side 2 which is formed of a synthetic resin, a waterproof layer on the surface side 3 which is formed of a synthetic resin, and an insulating layer 4 interposed between both layers 2 and 3. A hole for bonding 4a is provided in the insulating layer 4 and the waterproof layer on the skeleton side 2 and the waterproof layer on the surface side 3 are partially bonded and integrated with each other through the hold for bonding 4a.

As a synthetic resin constituting the waterproof layer on the skeleton side 2 and a synthetic resin constituting the waterproof layer on the surface side 3, which are not particularly limited, a vinyl chloride resin and a polypropylene elastomer are preferably used. Among these, it is particularly preferable to use a soft vinyl chloride resin from viewpoints of workability, durability, flame retardance, and production processability.

In a case where a vinyl chloride resin is used as a resin constituting the waterproof layer on the skeleton side 2 or the waterproof layer on the surface side 3, a plasticizer is blended with a resin composition constituting the waterproof layer on the skeleton side 2 or a resin composition constituting the waterproof layer on the surface side 3 from a viewpoint of providing plasticity and sufficient flexibility for the waterproof resin layer 1. As the plasticizer, which is not particularly limited, side chain alcohol phthalic acid ester or straight chain alcohol phthalic acid ester typified by DOP (di-2-ethylhexylphthalate) is used. Further, the blending amount of the plasticizer may be in the range of 30 parts by weight to 90 parts by weight based on 100 parts by weight of the synthetic resin. When the blending amount of the plasticizer according to the present embodiment exceeds the lower limit thereof, the functional layer 20 which is more excellent from a viewpoint of sufficiently exhibiting effects of the plasticizer can be obtained. In addition, when the blending amount thereof is less than the upper limit thereof, the functional layer 20 which is more excellent from a viewpoint of improving processability can be obtained.

In addition, it is preferable that an inorganic UV screening agent may be blended with the resin composition constituting the waterproof layer on the surface side 3. In this manner, since an effect of shielding UV rays of the waterproof layer on the surface side 3 can be improved, the durability of the waterproof layer on the surface side 3 can be improved and the endurance period of the waterproof resin layer 1 can be made longer.

In addition, various additives may be blended with the resin composition constituting the waterproof layer on the skeleton side 2 and the resin composition constituting the waterproof layer on the surface side 3 for the purpose of improving other properties of the waterproof resin layer. Examples of main additives include a stabilizer and an organic UV absorber. Moreover, examples of the stabilizer, which is not particularly limited, include organic tin maleate such as dibutyl tin maleate, organic acid barium salts, and organic acid zinc salts. In addition, examples of the organic UV absorber, which is not particularly limited, include benzotriazole and cyanoacrylate. In addition to these additives, an antioxidant, a processing aid, or a colorant may be suitably blended.

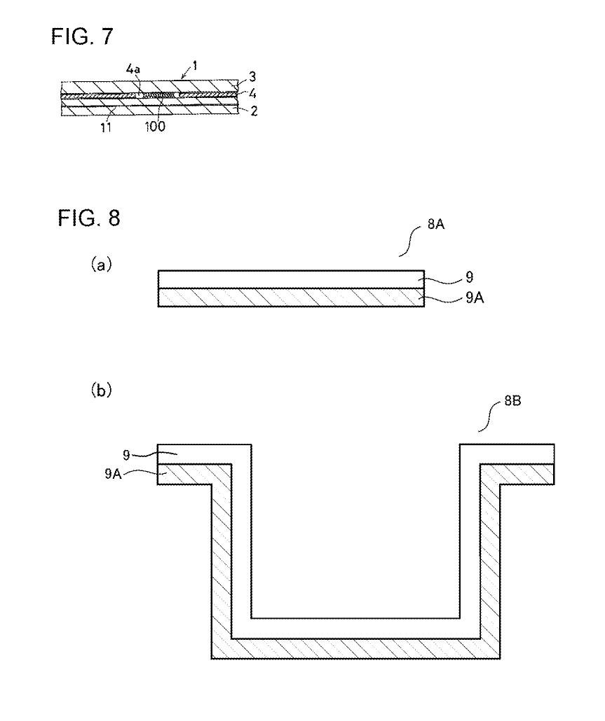

In addition, the waterproof layer on the skeleton side 2 and the waterproof layer on the surface side 3 may be reinforced by fibers, for example, inorganic fibers such as glass fibers and organic fibers such as polyester fibers in addition to layers formed of the above-described resin composition. For example, as illustrated in FIG. 7, a fiber layer 11 formed of reinforced fibers may be interposed and integrated with the position of the intermediate layer of the waterproof layer on the skeleton side 2.

The thickness of the waterproof layer on the skeleton side 2 may be in the range of 0.8 mm to 2.0 mm. When the thickness of the waterproof layer on the skeleton side 2 exceeds the lower limit thereof, it is preferable from a viewpoint of improving the waterproof durability of the waterproof layer on the skeleton side 2. Further, when the thickness thereof is less than the upper limit, it is preferable from viewpoints of the workability and the production cost of the waterproof resin layer. In addition, it is preferable that the thickness of the waterproof layer on the skeleton side 2 is in the range of 1.2 mm to 1.5 mm.

The thickness of the waterproof layer on the surface side 3 may be in the range of 1.0 mm to 2.5 mm. When the thickness of the waterproof layer on the surface side 3 exceeds the lower limit thereof, it is preferable from a viewpoint of improving the durability of the waterproof layer on the surface side. Further, when the thickness thereof is less than the upper limit, it is preferable from viewpoints of the workability and the production cost of the waterproof resin layer. In addition, it is preferable that the thickness of the waterproof layer on the surface side 3 is in the range of 1.5 mm to 2.0 mm.

The insulating layer 4 is not particularly limited as long as the layer can obtain the insulation effect between the waterproof layer on the skeleton side 2 and the waterproof layer on the surface side 3, that is, the layer can exhibit the insulation effect of preventing the waterproof layer on the skeleton side 2 from being adversely affected by cracks or the like of the waterproof layer on the surface side 3, and the layer has flexibility similar to the waterproof layer. Examples of the insulating layer 4, which is not particularly limited, for example, include woven fabrics such as glass cloth and polyester cloth; non-woven fabrics such as glass non-woven fabric and polyester non-woven fabric; foam sheets such as a polyethylene foam sheet and a polyester foam sheet; a thin layer sheet of polyethylene; a composite sheet of glass fibers and polyethylene; and aluminum foil.

In general, a plasticizer contained in the waterproof resin layer 1 formed of a vinyl chloride resin has properties of being gradually volatilized and disappearing from the surface of the waterproof resin layer 1 with time. Such phenomenon of volatilization and disappearing of the plasticizer is accelerated when affected by external factors such as sunlight or rainwater. In addition, the plasticizer in the waterproof resin layer moves toward the surface portion from the inside thereof and diffuses so as to compensate the volatilization or disappearing of the plasticizer in the vicinity of the surface. Further, when the remaining amount of the plasticizer is significantly decreased, the flexibility or elongation characteristics are degraded and a so-called embrittlement phenomenon occurs. The waterproof resin layer in which such an embrittlement phenomenon occurs becomes easily cracked due to thermal expansion or contraction accompanied by a change of the temperature. In the present embodiment, since the movement of the plasticizer which is a factor of causing the embrittlement phenomenon is prevented by the insulating layer 4 between the waterproof layer on the skeleton side 2 and the waterproof layer on the surface side 3, the flexibility and the elongation characteristics of the waterproof layer on the skeleton side 2 can be maintained with time. Accordingly, the service life of the waterproof resin layer 1 can be markedly extended.

The thickness of the insulating layer 4 varies depending on the quality of a material to be used, but it is preferable that the insulating layer 4 has a thickness in which a tear or the like is not generated at the time of handling during production and the insulation effect can be sufficiently exhibited even when any kind of material is used. Consequently, the upper limit of the thickness of the insulating layer 4 may be 1.0 mm and the function thereof can be exhibited without an increase in the thickness of the waterproof resin layer 1 when the thickness of the insulating layer is less than the upper limit thereof. Further, the upper limit of the thickness of the insulating layer 4 is preferably 0.5 mm.

A hole for bonding 4a that penetrates from the upper surface to the lower surface may be provided in the insulating layer 4. The waterproof layer on the skeleton side 2 and the waterproof layer on the surface side 3 are bonded and integrated with each other through the hole for bonding 4a.

The size of the hole for bonding 4a in the insulating layer 4 is preferably in the range of 10 cm² to 40 cm² and more preferably in the range of 15 cm² to 30 cm². When the size of the hole for bonding 4a exceeds the lower limit thereof, this is preferable from viewpoints of capability of sufficient bonding in a bonding portion 100 and the bonding strength of the waterproof layer 2 on the skeleton side and the waterproof layer 3 on the surface side at the time of production. In addition, when the size of the hole for bonding 4a is less than the upper limit thereof, since the insulating properties in the bonding portion 100 can be sufficiently obtained, this is preferable from viewpoints of exhibiting the insulation effect of the insulating layer 4 and the durability of the waterproof resin layer 1.

In addition, the ratio of providing the holes for bonding 4a in the insulating layer 4 may be 1 to 5 holes for bonding 4a and preferably 2 to 4 holes for bonding 4a per 1 m² of the insulating layer 4. When the ratio of providing the holes for bonding 4a in the insulating layer 4 exceeds the lower limit thereof, the functional layer 20 which is excellent from a viewpoint of the bonding and fixing strength of the waterproof layer on the surface side 3 against the waterproof layer on the skeleton side 2 after waterproof construction can be obtained. In addition, when the ratio thereof is less than the upper limit thereof, the functional layer 20 which is excellent from viewpoints of exhibiting the insulation effects and the durability of the waterproof resin layer 1 can be obtained.

Moreover, the shape of the hole for bonding 4a, which is not particularly limited, may be circular, square, hexagonal, or oval and the hole may have any other shapes.

In addition, the holes for bonding 4a in the present embodiment are dispersed and then arranged.

The waterproof layer on the skeleton side 2 and the waterproof layer on the surface side 3 are partially bonded and integrated with each other through the hole for bonding 4a of the insulating layer 4, but means for bonding is not particularly limited and examples thereof include heat fusion, welding using a solvent, and adhesion using an adhesive. Among these, heat fusion bonding is preferably used in terms of excellent workability and productivity.

Further, means for laminating the respective layers of the waterproof layer on the skeleton side 2, the insulating layer 4, and the waterproof layer on the surface side 3 at the time of obtaining the waterproof resin layer 1 is not particularly limited and the respective layers may be laminated with each other using a lamination method being generally used such as a laminate method or a press method.

For example, the following method can be used.

First, the insulating layer 4 having the hole for bonding 4a is laminated on the sheet-like waterproof layer on the skeleton side 2 according to the lamination method and then the waterproof layer on the surface side 3 is laminated on the insulating layer 4 according to the lamination method. According to the method, at the time of the latter second stage of lamination, due to the compression between pressure rolls after heating, partial bonding between the waterproof layer 2 on the skeleton side and the waterproof layer on the surface side 3 through the hole for bonding 4a of the laminating layer 4 can be performed concurrently with the lamination of the waterproof layer on the surface side 3. For this reason, the lamination using the lamination method is advantageous in terms of exceedingly excellent productivity.

The insulating layer 4 interposed between the waterproof layer on the skeleton side 2 and the waterproof layer on the surface side 3 may be bonded to any one layer between the waterproof layer on the skeleton side 2 and the waterproof layer on the surface side 3. Further, it is preferable that the insulating layer 4 is simply interposed between the waterproof layer on the skeleton side 2 and the waterproof layer on the surface side 3 without being bonded to both layers of the waterproof layer on the skeleton side 2 and the waterproof layer on the surface side 3 from a viewpoint of improving and functioning the insulation effect using the insulating layer 4 and the movement preventing properties of the plasticizer.

(V) Curable Resin Layer

Hereinafter, a curable resin layer used as the functional layer 20 will be described. When a curable resin layer is used as the functional layer 20, an article with excellent electromagnetic wave shielding properties and thermal conductivity and particularly excellent design properties can be obtained.

Examples of the curable resin layer include a layer (1) containing a curable resin and an inorganic pigment and a layer (2) that is formed of a surface layer material comprising a surface layer base material which supports a resin containing a melamine resin on one surface side and supports a solid content of a thermoplastic emulsion resin on the other surface side, but the curable resin layer is not limited thereto.

As a sheet containing the curable resin layer, “Decora” (manufactured by Sumitomo Bakelite Co., Ltd.) can be exemplified.

Hereinafter, a resin composition constituting the curable resin layer that contains the curable resin and inorganic pigment (1) described above will be described as an example.

The curable resin layer is formed of a resin composition containing the curable resin and the inorganic pigment.

Examples of the curable resin, which is not particularly limited, include a phenol resin such as a resol type resin or a novolac type resin; a bisphenol type epoxy resin such as a bisphenol A type resin or a bisphenol F type resin; an epoxy resin such as a novolac type epoxy resin or a biphenyl type epoxy resin; a urea resin; a melamine resin; an unsaturated polyester resin; a polyurethane resin; a diallyl phthalate resin; and a silicone resin. These may be used alone or in combination of two or more kinds thereof.

Among these, a melamine resin is preferably used as the curable resin. Since a melamine resin has high transparency and is unlikely to be discolored or to turn yellow, the color tone thereof expressed by the inorganic pigment is unlikely to be damaged. In addition, a decorative sheet with excellent surface hardness or chemical resistance and high surface impact strength can be obtained.

In a case where the curable resin is used, a curing agent or a curing accelerator can be used together as needed.

Examples of the inorganic pigment, which is not particularly limited, include white pigments such as titanium dioxide (titanium white), zinc oxide (zinc white), basic lead carbonate (lead white), strontium titanate, antimony oxide, and lithopone (mixed crystals of zinc sulfide and barium sulfate); and organic pigments such as red iron oxide, Prussian blue, navy blue, cobalt blue, and chrome green. These may be used alone or in combination of two or more kinds thereof.

Among these inorganic pigments, titanium dioxide is preferable as a white pigment. Since titanium dioxide has excellent characteristics such as whiteness, hiding property, and tinting property, these characteristics can be exhibited even though titanium dioxide with relatively low concentration is used.

As the particle diameter of the inorganic pigment, which is not particularly limited, an inorganic pigment having an average particle diameter of 0.1 μm to 1 μm and preferably 0.1 μm to 0.5 μm can be used. When the particle diameter of the inorganic pigment is in the above-described range, the smoothness of the surface of the functional layer 20 and the ability of shielding the color tone of the surface layer on the lower layer side become excellent.

In a case where the average particle diameter of the inorganic pigment exceeds the lower limit thereof, the ability of shielding the color tone of the surface layer on the lower layer side can be held and the viscosity at the time of preparing a resin composition varnish or the workability can become excellent. Meanwhile, the average particle diameter of the inorganic pigment is less than the upper limit of the above, the surface smoothness of the functional layer 20 becomes excellent.

The blending ratio of the inorganic pigment to the curable resin, which is not particularly limited, is in the range of 20 parts by weight to 100 parts by weight and preferably in the range of 40 parts by weight to 80 parts by weight based on 100 parts by weight of the curable resin. When the blending ratio of the inorganic pigment exceeds the upper limit thereof, the ability of shielding the color tone of the surface layer on the lower layer side can be held. Meanwhile, when the blending ratio thereof is less than the upper limit thereof, the viscosity at the time of preparing a resin composition varnish, the workability, and the surface smoothness of the functional layer 20 become excellent.

It is preferable that the resin composition contains a flexibility imparting agent in addition to the curable resin and the inorganic pigment. In this manner, the fluidity of the resin composition can be improved at the time of producing the functional layer 20 and thus the smoothness of the surface layer can be further improved. Moreover, it is possible to prevent generation of cracks on the surface layer.

Examples of the flexibility imparting agent, which is not particularly limited, include a polyvinyl acetal resin such as polyvinyl formal, polyvinyl acetal, or polyvinyl butyral, a silicone resin, silicone oil, acrylonitrile butadiene rubber, acrylic rubber, a phenoxy resin, and a fluorine resin. These can be used alone or in combination of two or more kinds thereof.

Among these flexibility imparting agents, a fluorine resin is preferable and a solvent-soluble type modified fluorine resin is more preferable. In this manner, the above-described effects can be exhibited without largely decreasing the hardness of the surface of the decorative sheet.

The blending amount of the flexibility providing agent is not particularly limited because the blending amount thereof varies depending on the kind of flexibility imparting agent to be used. However, a solvent-soluble type modified fluorine resin is used as the flexibility imparting agent, the blending amount thereof in the range of 0.5 parts by weight to 5 parts by weight and preferably in the range of 0.5 parts by weight to 2 parts by weight based on 100 parts by weight of the curable resin.

The above-described effects can be sufficiently expressed when the blending amount of the solvent-soluble type modified fluorine resin exceeds the lower limit thereof and the surface hardness of the functional layer 20 can be maintained when the blending amount thereof is less than the upper limit thereof. In addition, as such a solvent-soluble type fluorine resin, “New Garnet” (manufactured by TOHPE CORPORATION) can be used.

The resin composition may contain an organic pigment. As the organic pigment, both of a pigment which is insoluble in a solvent used when a resin composition varnish is prepared and a pigment which is soluble in a solvent thereof can be used.

In addition, a coupling agent or a surfactant can be used for the resin composition for the purpose of improving wettability of a curable resin and an inorganic pigment and dispersibility of an inorganic pigment in a resin composition varnish.

(Method of Bonding Functional Layer 20 and Main Body Portion 10)

Next, a method of bonding the functional layer 20 and the main body portion 10 according to the present embodiment will be described.

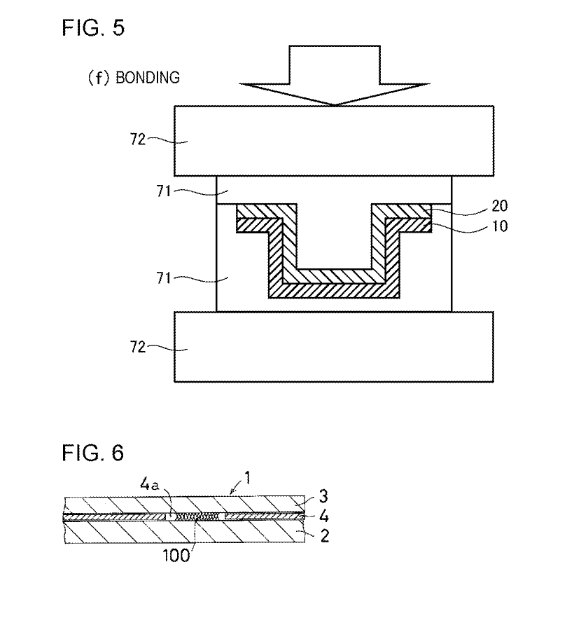

As the method of bonding the functional layer 20 and the main body portion 10, which is not particularly limited, they may be bonded to each other by providing the adhesive layer 30 so as to obtain the article illustrated in FIG. 3, insert forming may be performed, the functional layer 20 may be fused to the main body portion 10, or press forming illustrated in FIG. 5 may be performed. In addition, when a material forming the functional layer 20 is a thermoplastic resin, a method of bonding the functional layer 20 and the main body portion 10 by fusing the functional layer 20 and the main body portion 10 can be used. Meanwhile, when a material forming the functional layer 20 is a thermosetting resin, the main body portion 10 and the functional layer 20 can be subjected to press forming.

Moreover, when the main body portion 10 and the functional layer 20 formed of a thermosetting resin are subjected to press forming, it is preferable to use at least a B-stage-like layer as the functional layer 20. Further the main body portion 10 may be C-stage-like which is completely cured or B-stage-like. By bonding the functional portion and the main body portion 10 in this manner, an article with excellent electromagnetic wave shielding properties and thermal conductivity and at least one excellent characteristic from among abrasion resistance, waterproof properties, design properties, impact resistance, and flame retardance can be obtained.

As the adhesive layer 30, which is not particularly limited, a layer obtained by drying and curing a thermoplastic resin containing a solvent after being adhered, a layer formed of a photo-curable resin, a layer formed of a curable reactive resin, a layer formed of a thermosetting resin, a layer formed of a hot melt adhesive, and a layer formed of a gluing agent can be exemplified. Further, an adhesive having these plural properties together may be used. Examples of the adhesive, which is not particularly limited, include an acrylic adhesive, an epoxy adhesive, and a silicone adhesive.

Among these, when the adhesive layer 30 is formed of a photo-curable resin, since curing at room temperature is possible and the adhesive layer may become a material having a glass transition temperature of 200° C. or higher, this configuration is preferably used. Examples of the photo-curable resin include an acrylic resin and an epoxy resin.

In addition, when a material formed of a thermosetting resin is used, the adhesiveness with respect to a material containing silicon oxide or silicon nitride as a main component becomes easily excellent. Examples of the thermosetting resin include an epoxy resin and an unsaturated polyester resin.

Further, as the material of the adhesive layer 30, an epoxy crosslinked resin, an acrylic crosslinked resin, or unsaturated polyester can be used. These may be used alone or in combination of plural kinds thereof.

### Second Embodiment

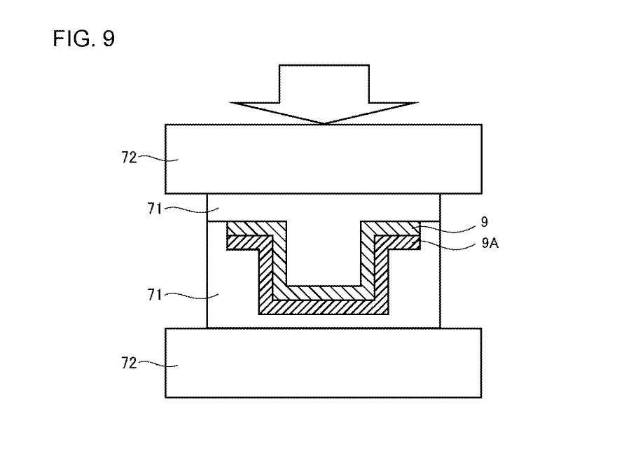

The outline of a laminate according to a second embodiment of the present invention will be described with reference to FIGS. 8 and 9.

As illustrated in FIG. 8, laminates 8A and 8B include a first layer 9 which is formed of a first material composition that contains a first fiber filler and a first resin binding the first resin filler and is obtained according the paper-making method and a second layer 9A which is formed of a second material composition that contains a second fiber filler and a second resin binding the second fiber filler and is obtained according to the paper-making method, and the first layer 9 and the second layer 9A are laminated with each other.

The first layer 9 and the second layer 9A constituting the laminates 8A and 8B of the present embodiment are formed of a composite material composition containing the fiber filler (A) and the resin (B) similar to those used for producing the paper-making sheet described above. The first layer 9 and the second layer 9A can be produced using a production method which is the same as that of the paper-making sheet described above. Further, the first fiber filler and the first resin used for the first layer 9 and the second fiber filler and the second resin used for the second layer 9A may be the same as or different from each other.

Examples of the method of laminating the first layer 9 and the second layer 9A include a heat press method, an adsorption method, and a spray coating method, but the method is not limited thereto. The lamination method can be suitably selected based on the kind of fiber filler and resin used for the first and second layers and the shape of the laminate to be obtained. When a heat press method is used, two sheets of sheet-like aggregates are generated in the same manner as the method of producing the paper-making sheet 10 illustrated in FIGS. 4(a) to 4(d). Next, two sheets of sheet-like aggregates are overlapped with each other and the sheet-like aggregates are heated and pressed by the press plate 71 as illustrated in FIG. 9. During the heat press process illustrated in FIG. 9, when a press plate having an uneven shape is used as the press plate 71 to press aggregates, it is possible to laminate two sheets of sheet-like aggregates with each other and to obtain a laminate which is subjected to bending processing into a desired shape. For example, in a case where a laminate is used as a case of a predetermined electronic component, a laminate having a predetermined shape can be produced using a press plate having a suitable dimension and shape for the electronic component to be used.

When the first layer 9 and second layer 9A are laminated with each other, the surface in which the first layer 9 and/or the second layer 9A is laminated may be roughened. When the surface is roughened, the adhesiveness of the lamination surface can be improved. As the method of roughening the surface, a method of reducing the blending amount of the resin (B) to be used and exposing the fiber filler (A) to the surface when the first layer 9 and/or the second layer 9A is produced using the paper-making method can be exemplified.

Further, in a case where one of the first layer 9 and the second layer 9A contains a thermoplastic resin and the other contains a thermosetting resin, the adhesiveness of the lamination surface can be improved by blending the thermoplastic resin with the thermosetting resin. This is because the thermoplastic resin is melted in the thermosetting resin and the melted resin functions as a binder when the first layer 9 and the second layer 9A are overlapped with each other and then pressed while being heated.

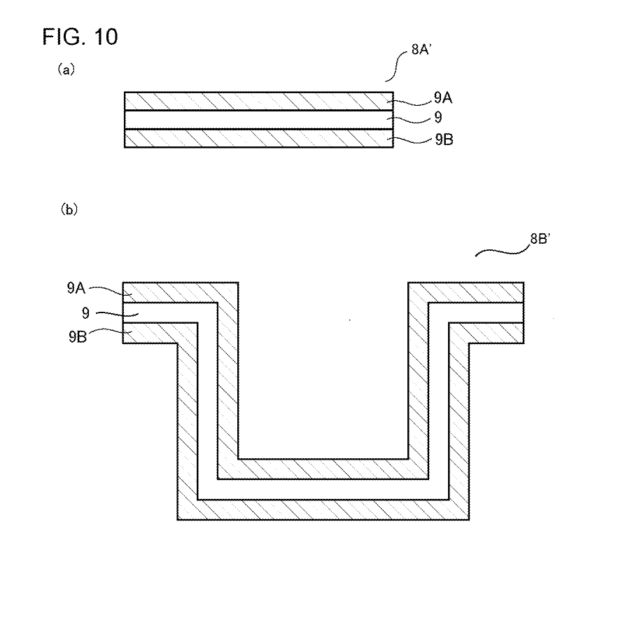

As illustrated in FIGS. 10(a) and 10(b), the laminates 8A′ and 8B′ may include at least one third layer 9B. The third layer is a layer which is formed of a third resin composition that contains a third fiber filler and a third resin binding the third fiber filler and is obtained by paper-making the third resin filler and the third resin. The third layer 9B is formed of a resin composition containing the fiber filler (A) and the resin (B) which are the same as those used for producing the paper-making sheet and can be produced using a production method which is the same method of producing the above-described paper-making sheet. The fiber filler (A), the resin (B), and other components used for the third layer may be the same as or different from those used for the first layer 9 and the second layer 9A.

In the present embodiment, the laminate may further include at least one metal layer made of a metal. The metal layer may be laminated between any of the first layer 9, the second layer 9A, and the third layer 9B or on any surface thereof. By providing the metal layer, the impact resistance of a laminate to be obtained can be improved.

According to an example of the present embodiment, by adjusting materials used for respective layers constituting a laminate, it is possible to form a laminate by combining layers having desired characteristics. For example, a laminate can be prepared such that the first layer 9 and the third layer 9B have thermal conductivity and the second layer 9A has electromagnetic wave shielding performance. Such a laminate can be used as a case that accommodates an electronic device. Specific examples thereof include a case that accommodates a smartphone, a case that accommodates an inverter, and a case that accommodates a battery. Such cases can be applied to a vehicle.

### Third Embodiment

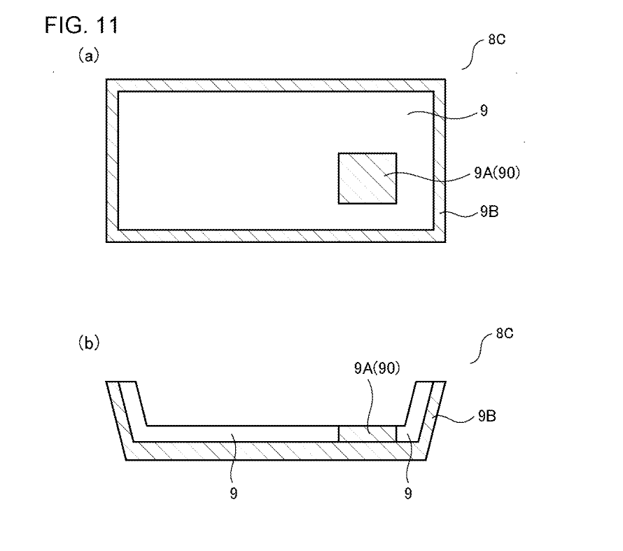

The outline of a laminate according to a third embodiment of the present invention will be described with reference to FIG. 11.

As illustrated in FIG. 11, a laminates 8C includes a first layer 9 which is formed of a first material composition that contains a first fiber filler and a first resin binding the first resin filler and is obtained according the paper-making method and a second layer 9A which is formed of a second material composition that contains a second fiber filler and a second resin binding the second fiber filler and is obtained according to the paper-making method, and an opening portion 90 is formed in the first layer 9. In addition, the second layer 9A may be fitted to the opening portion 90. FIG. 11(a) illustrates a top view of such a laminate 8C and FIG. 11(b) illustrates a cross-sectional view in the lamination direction. The shape of the opening portion 90 can be changed according to the use of the laminate.

In the present embodiment, the laminate 8C may include at least the third layer 9B. The third layer 9B is a layer which is formed of a third material composition that contains a third fiber filler and a third resin binding the third fiber filler and is obtained according to the paper-making method. The third layer 9B is formed of a material composition containing the fiber filler (A) and the resin (B) which are the same as those used for producing the above-described paper-making sheet and can be produced using the production method which is the same as the method of producing the above-described paper-making sheet.

A laminate having a structure in which the second layer 9A is fitted to a part of the first layer 9 can be prepared according to the following method.

The opening portion 90 can be prepared by preparing a paper-making sheet in the same manner as the method of producing the paper-making sheet 10 illustrated in FIGS. 4(a) to (d) described above and by performing post-processing on the paper-making sheet using a water jet or a punching blade.

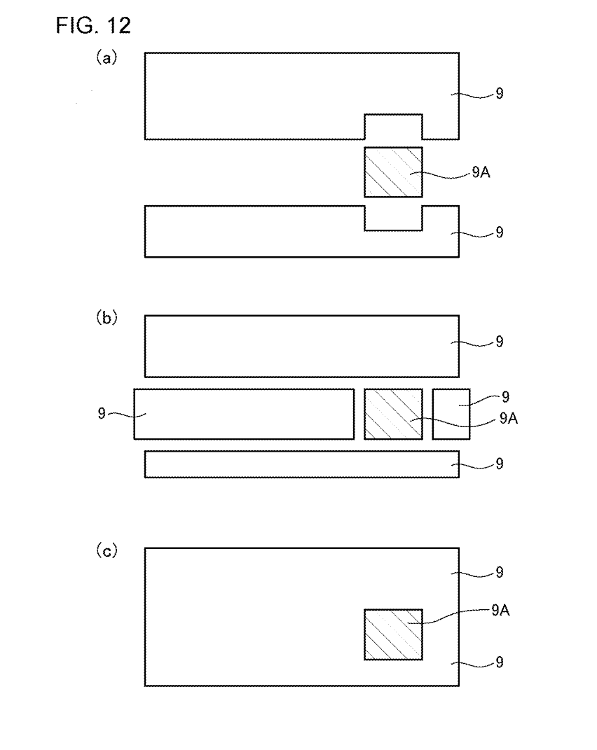

In addition, in a stage of performing press forming on aggregates illustrated in FIG. 4(e) described above, a part of the first layer with an uneven shape is prepared (FIG. 12(a)) at the stage of performing press forming using a press plate 71 having a desired shape. The first layer 9 having the opening portion 90 can be prepared by performing press forming on a part of the first layer having two sheets of uneven portions. Next, a laminate according to the present embodiment can be prepared by fitting the second layer 9A to the opening portion 90 (FIG. 12(c)) and then laminating the third layer 9B.

Alternatively, as illustrated in FIG. 12(b), one layer illustrated in FIG. 12(c) may be prepared by preparing each portion which becomes the first layer 9 and each portion which becomes the second layer 9B and then combining these.

Such a laminate 8C can be bent to have a desired form by being heated and pressed using a press plate in an uneven shape as illustrated in FIG. 9. The laminate 8C which is subjected to bending processing in this manner can be used as a case accommodating an electronic component.

For example, in a case where the electronic device is a smartphone, the laminate 8C is formed in a shape suitable for accommodating a smartphone as illustrated in FIG. 11. In this case, the first layer 9 prepared from a paper-making sheet with high bending strength is provided in a portion of the laminate 8C in contact with the smartphone. A region of the first layer 9 in contact with a heating portion of the smartphone is provided with the opening portion 90 and the second layer 9A prepared from the paper-making sheet which has high thermal emissivity is fitted to the opening portion 90. In addition, the third layer 9B covering the first layer 9 and the second layer 9A is prepared from the paper-making sheet having electromagnetic shielding performance that protects the smartphone from electromagnetic waves.

Hereinbefore, the embodiments of the present invention have been described with reference to the drawings, but these are merely examples of the present invention and various configurations other than those described above can be employed.

For example, in the third embodiment, the paper-making sheet having a rectangular opening portion is described as an example, but the shape of the opening portion can be optional.

### EXAMPLES

Hereinafter, the present invention will be described in detail with reference to Examples, but the present invention is not limited thereto. Further, “parts” and “%” described in Examples and Comparative Examples respectively indicate “parts by mass” and “% by mass.”

The raw materials described in Examples are expressed by parts by mass from which the moisture content contained in advance is removed.

(Paper-Making Sheet for Shielding Electromagnetic Waves)

1. Preparation of Composite Resin Composition

### (1) Production Example 1

45 parts of a solid resol resin (PR-51723, manufactured by Sumitomo Bakelite Co., Ltd.) which was crushed using an atomizer crusher to have an average particle diameter of 100 μm, 2 parts of Bentonite (Kunipia (trade name) manufactured by KUNIMINE INDUSTRIES CO., LTD.), 1 part of stainless fiber having a fiber length of 5 mm and a fiber diameter of 6 μm (NASLON (trade name) manufactured by Nippon Seisen Co., Ltd.), 12 parts of Kevlar (registered trademark) pulp 1F303 (manufactured by DU PONT-TORAY CO., LTD.), and 40 parts of Technora (registered trademark) fiber T32PNW (manufactured by TEIJIN TECHNO PRODUCTS LIMITED) were added to 10000 parts of water, the mixture was stirred using a disperser for 30 minutes, 900 ppm of polyethylene oxide having a molecular weight of 1000000 (manufactured by Wako Pure Chemical Industries, Ltd.) which was solved in water in advance was added thereto based on the total mass of the above-described all constituent materials, and then the constituent materials were aggregated in flocks. The aggregates were separated from water using a metal mesh having 80 meshes, dehydrated and pressed, and put into a drier at a temperature of 70° C. for 6 hours to be dried, thereby obtaining a composite resin composition with a yield of 99%. Further, a method of measuring the yield will be described below in detail.

### (2) Production Example 2

45 parts of a solid resol resin (PR-51723, manufactured by Sumitomo Bakelite Co., Ltd.) which was crushed using an atomizer crusher to have an average particle diameter of 100 μm, 5 parts of Bentonite (Kunipia (trade name) manufactured by KUNIMINE INDUSTRIES CO., LTD.), 4 parts of stainless fiber having a fiber length of 5 mm and a fiber diameter of 6 μm (NASLON (trade name) manufactured by Nippon Seisen Co., Ltd.), 6 parts of Kevlar (registered trademark) pulp 1F303 (manufactured by DU PONT-TORAY CO., LTD.), and 40 parts of Technora (registered trademark) fiber T32PNW (manufactured by TEIJIN TECHNO PRODUCTS LIMITED) were added to 10000 parts of water, the mixture was stirred using a disperser for 30 minutes, 0.3% of polyethylene oxide having a molecular weight of 1000000 (manufactured by Wako Pure Chemical Industries, Ltd.) which was solved in water in advance was added thereto based on the total mass of the above-described all constituent materials, and then the constituent materials were aggregated in flocks. The aggregates were separated from water using a metal mesh having 80 meshes, dehydrated and pressed, and put into a drier at a temperature of 70° C. for 6 hours to be dried, thereby obtaining a composite resin composition with a yield of 99%.

### (3) Production Example 3

30 parts of a solid resol resin (PR-51723, manufactured by Sumitomo Bakelite Co., Ltd.) which was crushed using an atomizer crusher to have an average particle diameter of 100 μm, 3 parts of Bentonite (Kunipia (trade name) manufactured by KUNIMINE INDUSTRIES CO., LTD.), 32 parts of stainless fiber having a fiber length of 5 mm and a fiber diameter of 6 μm (NASLON (trade name) manufactured by Nippon Seisen Co., Ltd.), 10 parts of Kevlar (registered trademark) pulp 1F303 (manufactured by DU PONT-TORAY CO., LTD.), and 25 parts of Technora (registered trademark) fiber T32PNW (manufactured by TEIJIN TECHNO PRODUCTS LIMITED) were added to 10000 parts of water, the mixture was stirred using a disperser for 30 minutes, 0.5% of polyethylene oxide having a molecular weight of 1000000 (manufactured by Wako Pure Chemical Industries, Ltd.) which was solved in water in advance was added thereto based on the total mass of the above-described all constituent materials, and then the constituent materials were aggregated in flocks. The aggregates were separated from water using a metal mesh having 80 meshes, dehydrated and pressed, and put into a drier at a temperature of 70° C. for 6 hours to be dried, thereby obtaining a composite resin composition with a yield of 96%.

### (4) Production Example 4

45 parts of an acrylonitrile-styrene copolymer (AS) resin (CEVIAN N (trade name) manufactured by Daicel Industry Co., Ltd.) which was crushed using a freeze crusher to have an average particle diameter of 300 μm, 5 parts of scaly silica microparticles (SUNLOVELY (trade name) manufactured by AGC Si-Tech Co., Ltd.), 5 parts of stainless fiber having a fiber length of 5 mm and a fiber diameter of 6 μm (NASLON (trade name) manufactured by Nippon Seisen Co., Ltd.), and 45 parts of polyvinyl alcohol fibers (Vinylon (trade name) manufactured by KURARAY CO., LTD.) having a fiber diameter of 22 μm and a fiber length of 5 mm were added to 10000 parts of water, the mixture was stirred using a disperser for 30 minutes, 0.4% of cationic polyacrylamide (manufactured by Harima Chemicals, Inc.) which was solved in water in advance was added thereto based on the total mass of the above-described all constituent materials, and then the constituent materials were aggregated in flocks. The aggregates were separated from water using a metal mesh having 40 meshes, dehydrated and pressed, and put into a drier at a temperature of 130° C. for 6 hours to be dried, thereby obtaining a composite resin composition with a yield of 92%.

### (5) Production Example 5

10 parts of epoxy resin 1002 (manufactured by Mitsubishi Chemical Corporation) which was crushed using a high-pressure homogenizer to have an average particle diameter of 30 μm, 1 part of imidazole-based epoxy resin curing agent 2PZ-PW (manufactured by SHIKOKU CHEMICALS CORPORATION), 3 parts of synthetic saponite (Sumecton SA (trade name) manufactured by KUNIMINE INDUSTRIES CO., LTD.), 77 parts of copper fibers having a fiber length of 3 mm and a fiber diameter of 60 μm (manufactured by Kogi Corporation Co, Ltd.), 5 parts of stainless fiber having a fiber length of 5 mm and a fiber diameter of 6 μm (NASLON (trade name) manufactured by Nippon Seisen Co., Ltd.), and 4 parts of cellulose pulp (NDPT (trade name) Nippon Paper Chemicals Co., Ltd.) were added to 10000 parts of water, the mixture was stirred using a disperser for 30 minutes, 0.3% of cationic starch SC-5 (manufactured by Sanwa Starch Co., Ltd.) which was solved in water in advance was added thereto based on the total mass of the above-described all constituent materials, and then the constituent materials were aggregated in flocks. The aggregates were separated from water using a metal mesh having 40 meshes, dehydrated and pressed, and put into a drier at a temperature of 100° C. for 4 hours to be dried, thereby obtaining a composite resin composition with a yield of 95%.

2. Preparation of Paper-Making Sheet

### (1) Production Example 6

The composite resin composition obtained in Production Example 1 was set in a mold coated with a release agent and compression forming was performed on the composite resin composition at a temperature of 180° C. under the surface pressure of 30 MPa for 10 minutes, thereby obtaining a paper-making sheet having a dimension of a height of 10 cm, a width of 10 cm, and a thickness of 2 mm.

### (2) Production Example 7

The composite resin composition obtained in Production Example 2 was set in a mold coated with a release agent and compression forming was performed on the composite resin composition at a temperature of 180° C. under the surface pressure of 30 MPa for 10 minutes, thereby obtaining a paper-making sheet having a dimension of a height of 10 cm, a width of 10 cm, and a thickness of 2 mm.

### (3) Production Example 8

The composite resin composition obtained in Production Example 3 was set in a mold coated with a release agent and compression forming was performed on the composite resin composition at a temperature of 180° C. under the surface pressure of 30 MPa for 10 minutes, thereby obtaining a paper-making sheet having a dimension of a height of 10 cm, a width of 10 cm, and a thickness of 2 mm.

### (4) Production Example 9

The composite resin composition obtained in Production Example 4 was set in a mold coated with a release agent, compression forming was performed on the composite resin composition at a temperature of 200° C. under the surface pressure of 15 MPa for 10 minutes, and the mold was cooled to a temperature of 50° C., thereby obtaining a paper-making sheet having a dimension of a height of 10 cm, a width of 10 cm, and a thickness of 2 mm.

### (5) Production Example 10

The composite resin composition obtained in Production Example 5 was set in a mold coated with a release agent and compression forming was performed on the composite resin composition at a temperature of 160° C. under the surface pressure of 10 MPa for 60 minutes, thereby obtaining a paper-making sheet having a dimension of a height of 10 cm, a width of 10 cm, and a thickness of 2 mm.

Evaluation of characteristics described below was performed using paper-making sheets obtained in Production Examples 6 to 10. The results thereof are listed in Table 1.

TABLE 1

| | Specific | Electric field | Electric field | Electric field | Magnetic field | | Bending | Linear |
|---|---|---|---|---|---|---|---|---|
| | gravity of | wave shielding | wave shielding | wave shielding | wave shielding | Bending | elastic | expansion |
| | paper-making | properties at | properties at | properties at | properties at | strength | modulus | coefficient |
| | sheet | 100 MHz (dB) | 500 MHz (dB) | 800 MHz (dB) | 800 MHz (dB) | (MPa) | (GPa) | (ppm/° C.) |
| Production | 1.30 | 28 | 21 | 20 | 5 | 330 | 12 | 5 |
| Example 6 | | | | | | | | |
| Production | 1.35 | 48 | 42 | 40 | 30 | 330 | 13 | 6 |
| Example 7 | | | | | | | | |
| Production | 1.81 | 70 | 55 | 48 | 55 | 380 | 16 | 5 |
| Example 8 | | | | | | | | |
| Production | 1.27 | 50 | 44 | 42 | 42 | 90 | 8 | 46 |
| Example 9 | | | | | | | | |
| Production | 4.48 | 65 | 50 | 44 | 50 | 80 | 17 | 37 |
| Example 10 | | | | | | | | |

3. Evaluation Method of Characteristics

3.1 Composite Resin Composition

(1) Yield

The yield was calculated according to the following formula.

Yield(%)=(weight of obtained composite resin composition/total weight of prepared raw materials of composite resin composition)×100

The weight of the composite resin composition after drying was used for the obtained composite resin composition and the weight from which the moisture content was removed was used for the total weight of the prepared raw materials of the composite resin composition.

3.2 Paper-Making Sheet

(1) Measurement of Specific Gravity

The specific gravity thereof was measured in conformity with JIS K 6911 (thermosetting plastic general test method). A test piece which was cut out from the paper-making sheet so as to have a dimension of a height of 2 cm, a width of 2 cm, and a thickness of 2 mm was used.

(2) Measurement of Electromagnetic Wave Shielding Rate

A paper-making sheet with a dimension of a height of 12 cm, a width of 12 cm, and a thickness of 1 mm was prepared under the forming conditions which were the same as those of the obtained paper-making sheet with a dimension of a height of 10 cm, a width of 10 cm, and a thickness of 2 mm and the prepared paper-making sheet was used as a test piece. Next, the evaluation was performed according to a KEC method. The KEC method, which was proposed by KEC Electronic Industry Development Center, is a method of measuring the attenuance of the electromagnetic wave through a test piece using a spectrum analyzer after the test piece is interposed in a symmetrically divided shield box.

An example of the relationship between the electromagnetic wave shielding properties and the electromagnetic wave shielding rate is as follows.

The electromagnetic wave shielding properties 60 dB indicates an electromagnetic wave shielding rate of 99.9%.

The electromagnetic wave shielding properties 40 dB indicates an electromagnetic wave shielding rate of 99.0%.

The electromagnetic wave shielding properties 20 dB indicates an electromagnetic wave shielding rate of 90.0%.

(3) Bending Test

The bending test was performed in conformity with JIS K 6911 (thermosetting plastic general test method). A test piece which was cut out from the paper-making sheet so as to have a dimension of a height of 50 cm, a width of 25 cm, and a thickness of 2 mm was used. The distance between fulcrums of the bending test was 32 mm.

(4) Measurement of Linear Expansion Coefficient in Planar Direction

A paper-making sheet with a dimension of a height of 5 mm, a width of 30 mm, and a length of 10 mm was prepared under the condition of the forming time being three times that in which a paper-making sheet with a dimension of a height of 10 cm, width of 10 cm, and a thickness of 2 mm was obtained and then cut into test pieces with a dimension of a height of 5 mm, a width of 5 mm, and a length of 10 mm, and then the linear expansion coefficient in the length direction was measured using a thermo-mechanical analyzer (TMA-6000, manufactured by Seiko Instruments, Inc.). The temperature increasing rate was set to 5° C./min and the linear expansion coefficient (al) was acquired in a temperature range of 80° C. to 120° C.

In all Production Examples 1 to 5, composite resin compositions were obtained with high yields. Further, in all Production Examples 6 to 10, the electric field wave shielding wave properties at 800 MHz were equal to or higher than 20 dB, the bending strength was equal to or more than 80 MPa, and the bending elastic modulus was equal to or more than 8 GPa. In addition, the specific gravity was equal to or more than 1 and equal to or less than 5 and the linear thermal coefficient in the planar direction was equal to or more than 0.1 ppm/° C. and equal to or less than 50 ppm/° C. Thus, it was understood that a paper-making sheet with excellent balance among characteristic was obtained.

In addition, when the paper-making sheet obtained in Production Example 6 was laminated with a build-up substrate and thermally cured, so that the paper-making sheet was attached to the build-up substrate, it was possible to shield the electromagnetic waves and reinforce the substrate. Similarly, when each of the paper-making sheets obtained in Production Examples 7 to 10 was laminated with a build-up substrate and thermally cured so that the paper-making sheet was attached to the build-up substrate, it was possible to shield the electromagnetic waves and reinforce the substrate.

(Paper-Making Sheet for Heat Radiation)

1. Preparation of Composite Resin Composition

### (1) Production Example 11

24 parts of epoxy resin 1002 (manufactured by Mitsubishi Chemical Corporation) which was crushed using a high-pressure homogenizer to have an average particle diameter of 30 μm, 1 part of imidazole-based epoxy resin curing agent 2PZ-PW (manufactured by SHIKOKU CHEMICALS CORPORATION), 5 parts of synthetic saponite (Sumecton SA (trade name) manufactured by KUNIMINE INDUSTRIES CO., LTD.), 60 parts of aluminum fibers having a fiber length of 3 mm and a fiber diameter of 60 μm (material: A1070, manufactured by Kogi Corporation Co., Ltd.), and 10 parts of cellulose pulp (NDPT (trade name) Nippon Paper Chemicals Co., Ltd.) were added to 10000 parts of water, the mixture was stirred using a disperser for 30 minutes, 0.4% of cationic starch SC-5 (manufactured by Sanwa Starch Co., Ltd.) which was solved in water in advance was added thereto based on the mass of the constituent materials, and then the constituent materials were aggregated in flocks. The aggregates were separated from water using a metal mesh having 40 meshes, dehydrated and pressed, and put into a drier at a temperature of 100° C. for 4 hours to be dried, thereby obtaining a composite resin composition with a yield of 94%. The method of measuring the yield is described below.

### (2) Production Example 12

10 parts of epoxy resin 1002 (manufactured by Mitsubishi Chemical Corporation) which was crushed using a high-pressure homogenizer to have an average particle diameter of 30 μm, 1 part of imidazole-based epoxy resin curing agent 2PZ-PW (manufactured by SHIKOKU CHEMICALS CORPORATION), 3 parts of synthetic saponite (Sumecton SA (trade name) manufactured by KUNIMINE INDUSTRIES CO., LTD.), 82 parts of copper fibers having a fiber length of 3 mm and a fiber diameter of 60 μm (manufactured by Kogi Corporation Co, Ltd.), and 4 parts of cellulose pulp (NDPT (trade name) Nippon Paper Chemicals Co., Ltd.) were added to 10000 parts of water, the mixture was stirred using a disperser for 30 minutes, 0.3% of cationic starch SC-5 (manufactured by Sanwa Starch Co., Ltd.) which was solved in water in advance was added thereto based on the mass of the constituent materials, and then the constituent materials were aggregated in flocks. The aggregates were separated from water using a metal mesh having 40 meshes, dehydrated and pressed, and put into a drier at a temperature of 100° C. for 4 hours to be dried, thereby obtaining a composite resin composition with a yield of 95%.

### (3) Production Example 13

40 parts of a solid resol resin (PR-51723, manufactured by Sumitomo Bakelite Co., Ltd.) which was crushed using an atomizer crusher to have an average particle diameter of 100 μm, 5 parts of Bentonite (Kunipia (trade name) manufactured by KUNIMINE INDUSTRIES CO., LTD.), 25 parts of aluminum fibers having a fiber length of 3 mm and a fiber diameter of 90 μm (material: A1070, manufactured by Kogi Corporation Co., Ltd.), 5 parts of Kevlar (registered trademark) pulp 1F303 (manufactured by DU PONT-TORAY CO., LTD.), and 25 parts of Technora (registered trademark) fiber T32PNW (manufactured by TEIJIN TECHNO PRODUCTS LIMITED) were added to 10000 parts of water, the mixture was stirred using a disperser for 30 minutes, 0.2% of polyethylene oxide having a molecular weight of 1000000 (manufactured by Wako Pure Chemical Industries, Ltd.) which was solved in water in advance was added thereto based on the mass of the constituent materials, and then the constituent materials were aggregated in flocks. The aggregates were separated from water using a metal mesh having 40 meshes, dehydrated and pressed, and put into a drier at a temperature of 70° C. for 6 hours to be dried, thereby obtaining a composite resin composition with a yield of 97%.

### (4) Production Example 14

35 parts of a solid resol resin (PR-51723, manufactured by Sumitomo Bakelite Co., Ltd.) which was crushed using an atomizer crusher to have an average particle diameter of 100 μm, 5 parts of Bentonite (Kunipia (trade name) manufactured by KUNIMINE INDUSTRIES CO., LTD.), 40 parts of aluminum fibers having a fiber length of 3 mm and a fiber diameter of 90 μm (material: A1070, manufactured by Kogi Corporation Co., Ltd.), 5 parts of Kevlar (registered trademark) pulp 1F303 (manufactured by DU PONT-TORAY CO., LTD.), and 15 parts of Technora (registered trademark) fiber T32PNW (manufactured by TEIJIN LIMITED) were added to 10000 parts of water, the mixture was stirred using a disperser for 30 minutes, 0.5% of polyethylene oxide having a molecular weight of 1000000 (manufactured by Wako Pure Chemical Industries, Ltd.) which was solved in water in advance was added thereto based on the mass of the constituent materials, and then the constituent materials were aggregated in flocks. The aggregates were separated from water using a metal mesh having 40 meshes, dehydrated and pressed, and put into a drier at a temperature of 70° C. for 6 hours to be dried, thereby obtaining a composite resin composition with a yield of 94%.

### (5) Production Example 15

35 parts of a solid resol resin (PR-51723, manufactured by Sumitomo Bakelite Co., Ltd.) which was crushed using an atomizer crusher to have an average particle diameter of 100 μm, 5 parts of Bentonite (Kunipia (trade name) manufactured by KUNIMINE INDUSTRIES CO., LTD.), 40 parts of aluminum fibers having a fiber length of 3 mm and a fiber diameter of 90 μm (material: A5052, manufactured by Kogi Corporation Co., Ltd.), 5 parts of Kevlar (registered trademark) pulp 1F303 (manufactured by DU PONT-TORAY CO., LTD.), and 15 parts of Technora (registered trademark) fiber T32PNW (manufactured by TEIJIN TECHNO PRODUCTS LIMITED) were added to 10000 parts of water, the mixture was stirred using a disperser for 30 minutes, 0.5% of polyethylene oxide having a molecular weight of 1000000 (manufactured by Wako Pure Chemical Industries, Ltd.) which was solved in water in advance was added thereto based on the mass of the constituent materials, and then the constituent materials were aggregated in flocks. The aggregates were separated from water using a metal mesh having 40 meshes, dehydrated and pressed, and put into a drier at a temperature of 70° C. for 6 hours to be dried, thereby obtaining a composite resin composition with a yield of 94%.

### (6) Production Example 16

30 parts of an acrylonitrile-styrene copolymer (AS) resin (CEVIAN N (trade name) manufactured by Daicel Industry Co., Ltd.) which was crushed using a freeze crusher to have an average particle diameter of 200 μm, 5 parts of scaly silica microparticles (SUNLOVELY (trade name) manufactured by AGC Si-Tech Co., Ltd.), 10 parts of copper fibers having a fiber length of 3 mm and a fiber diameter of 90 μm (manufactured by Kogi Corporation Co., Ltd.), 40 parts of copper powder having an average particle diameter of 20 μm (CUE13PB (trade name), manufactured by KOJUNDO CHEMICAL LABORATORY CO., LTD.), and 15 parts of polyvinyl alcohol fibers (Vinylon (trade name) manufactured by KURARAY CO., LTD.) having a fiber diameter of 22 μm and a fiber length of 5 mm were added to 10000 parts of water, the mixture was stirred using a disperser for 30 minutes, 0.5% of cationic polyacrylamide (manufactured by Harima Chemicals, Inc.) which was solved in water in advance was added thereto based on the mass of the constituent materials, and then the constituent materials were aggregated in flocks. The aggregates were separated from water using a metal mesh having 80 meshes, dehydrated and pressed, and put into a drier at a temperature of 130° C. for 6 hours to be dried, thereby obtaining a composite resin composition with a yield of 90%.

2. Preparation of Paper-Making Sheet

### (1) Production Example 17

The composite resin composition obtained in Production Example 1 was set in a mold coated with a release agent and compression forming was performed on the composite resin composition at a temperature of 160° C. under the surface pressure of 10 MPa for 60 minutes, thereby obtaining a paper-making sheet having a dimension of a height of 10 cm, a width of 10 cm, and a thickness of 2 mm.

### (2) Production Example 18

The composite resin composition obtained in Production Example 2 was set in a mold coated with a release agent and compression forming was performed on the composite resin composition at a temperature of 160° C. under the surface pressure of 10 MPa for 60 minutes, thereby obtaining a paper-making sheet having a dimension of a height of 10 cm, a width of 10 cm, and a thickness of 2 mm.

### (3) Production Example 19

The composite resin composition obtained in Production Example 3 was set in a mold coated with a release agent and compression forming was performed on the composite resin composition at a temperature of 180° C. under the surface pressure of 30 MPa for 10 minutes, thereby obtaining a paper-making sheet having a dimension of a height of 10 cm, a width of 10 cm, and a thickness of 2 mm.

### (4) Production Example 20

The composite resin composition obtained in Production Example 4 was set in a mold coated with a release agent and compression forming was performed on the composite resin composition at a temperature of 180° C. under the surface pressure of 30 MPa for 10 minutes, thereby obtaining a paper-making sheet having a dimension of a height of 10 cm, a width of 10 cm, and a thickness of 2 mm.

### (5) Production Example 21

The composite resin composition obtained in Production Example 5 was set in a mold coated with a release agent and compression forming was performed on the composite resin composition at a temperature of 180° C. under the surface pressure of 30 MPa for 10 minutes, thereby obtaining a paper-making sheet having a dimension of a height of 10 cm, a width of 10 cm, and a thickness of 2 mm.

### (6) Production Example 22

The composite resin composition obtained in Production Example 6 was set in a mold coated with a release agent, compression forming was performed on the composite resin composition at a temperature of 200° C. under the surface pressure of 10 MPa for 10 minutes, and the temperature of the mold was cooled to 50° C., thereby obtaining a paper-making sheet having a dimension of a height of 10 cm, a width of 10 cm, and a thickness of 2 mm.

Evaluation of characteristics described below was performed using paper-making sheets obtained in Production Examples 17 to 22. The results thereof are listed in Table 2.

TABLE 2

| | | Thermal | Thermal | | | |
|---|---|---|---|---|---|---|
| | Specific gravity | conductivity | conductivity | Bending | | Linear expansion |
| | of paper-making | in planar | in thickness | strength | Bending elastic | coefficient |
| | sheet | direction (W/mK) | direction (W/mK) | (MPa) | modulus (GPa) | (ppm/° C.) |
| Production | 1.92 | 38.2 | 3.0 | 90 | 17 | 35 |
| Example 17 | | | | | | |
| Production | 4.48 | 50.5 | 3.4 | 80 | 17 | 40 |
| Example 18 | | | | | | |
| Production | 1.56 | 5.2 | 0.6 | 270 | 12 | 10 |
| Example 19 | | | | | | |
| Production | 1.73 | 18.2 | 1.3 | 210 | 15 | 20 |
| Example 20 | | | | | | |
| Production | 1.72 | 8.0 | 1.1 | 220 | 16 | 22 |
| Example 21 | | | | | | |
| Production | 2.29 | 5.1 | 2.5 | 80 | 9 | 47 |
| Example 22 | | | | | | |

3. Evaluation Method of Characteristics (First Method)

3.1 Composite Resin Composition

(1) Yield

The yield was calculated according to the following formula.

Yield(%)=(weight of obtained composite resin composition/total weight of prepared raw materials of composite resin composition)×100

The weight of the composite resin composition after drying was used for the obtained composite resin composition and the weight from which the moisture content was removed was used for the total weight of the prepared raw materials of the composite resin composition.

3.2 Paper-Making Sheet

(1) Measurement of Specific Gravity

The specific gravity thereof was measured in conformity with JIS K 6911 (thermosetting plastic general test method). A test piece which was cut out from the paper-making sheet so as to have a dimension of a height of 2 cm, a width of 2 cm, and a thickness of 2 mm was used.

(2) Measurement of Thermal Conductivity

A paper-making sheet with a dimension of a height of 10 mm, a width of 10 mm, and a length of 3 mm was prepared under the condition of the forming time being three times that in which a paper-making sheet with a dimension of a height of 10 cm, a width of 10 cm, and a thickness of 2 mm was obtained, for measurement in the planar direction. Further, a paper-making sheet with a dimension of a height of 10 cm, a width of 10 cm, and a length of 1.5 mm was prepared under the same conditions as the forming conditions in which a paper-making sheet with a dimension of a height of 10 cm, a width of 10 cm, and a thickness of 2 mm was obtained, for measurement in the thickness direction. Obtained respective paper-making sheets were cut so as to have a dimension of a height of 10 mm, a width of 10 mm, and a length of 1.5 mm and then these cut paper-making sheets were set as test pieces. Next, the thermal conductivity of plate-like test pieces in the length direction was measured according to a laser flash method using Xe flash analyzer LFA447 (manufactured by NETZSCH, Inc.). The measurement was performed at a temperature of 25° C. under an air atmosphere.

(3) Bending Test

The bending test was performed in conformity with JIS K 6911 (thermosetting plastic general test method). A test piece which was cut out from the paper-making sheet so as to have a dimension of a height of 50 mm, a width of 25 mm, and a thickness of 2 mm was used. The distance between fulcrums of the bending test was 32 mm.

(4) Measurement of Linear Expansion Coefficient

A paper-making sheet with a dimension of a height of 5 mm, a width of 30 mm, and a length of 10 mm was prepared under the condition of the forming time being three times that in which a paper-making sheet of height of 10 cm, a width of 10 cm, and a thickness of 2 mm was obtained and then cut into test pieces with a dimension of a height of 5 mm, a width of 5 mm, and a length of 10 mm and then the linear expansion coefficient in the length direction was measured using a thermo-mechanical analyzer (TMA-6000, manufactured by Seiko Instruments, Inc.). The temperature increasing rate was set to 5° C./min and the linear expansion coefficient (al) was acquired in a temperature range of 80° C. to 120° C.

Evaluation of characteristics described below was performed using paper-making sheets obtained in Production Examples 19 and 20. The results thereof are listed in Table 3.

TABLE 3

| | Infrared |
|---|---|
| | emissivity (%) |
| Production Example 19 | 0.91 |
| Production Example 20 | 0.89 |

4. Evaluation Method of Characteristics (Second Method)

4.1 Paper-Making Sheet

(1) Measurement of Infrared Emissivity

After test pieces were heated and the temperature thereof reached the equilibrium temperature, infrared spectral radiation spectra were measured under the conditions of a measurement temperature of 80° C. in the case of test pieces from Production Examples 9 and 10 and Comparative Example 8 and a measurement temperature of 250° C. in the case of a test piece from Comparative Example 7 and a measurement wavelength of 4.4 μm to 15.4 μm, and the integral emissivity (%) was acquired using FT-IR (Fourier transform infrared spectrophotometer). In addition, test pieces cut out from the paper-making sheets so as to have a dimension of a height of 4 cm, a width of 4 cm, and a thickness of 1 mm were used.

In all Production Examples 11 to 16, composite resin compositions with high yields were obtained. Further, in all Production Examples 17 to 22, the thermal conductivity in the planar direction was equal to or more than 5 W/mK, the thermal conductivity in the thickness direction was less than or equal to a half of the thermal conductivity in the planar direction, the bending strength was equal to or more than 80 MPa, and the bending elastic modulus was equal to or more than 8 GPa. In addition, the specific gravity was equal to or more than 1 and equal to or less than 5 and the linear thermal coefficient in the planar direction was equal to or more than 0.1 ppm/° C. and equal to or less than 50 ppm/° C. Thus, it was understood that a paper-making sheet with excellent balance among characteristics was obtained.

Further, in Production Examples 19 to 21, the thermal conductivity in the planar direction was equal to or more than 5 W/mK even in a case where organic fibers were used in combination and thus paper-making sheets which showed excellent thermal conductivity not being damaged even when organic fibers were used in combination and excellent mechanical characteristics, for example, a bending strength of equal to or more than 200 MPa, were obtained.

In addition, respective functional layers having the following configurations (I) to (V) were bonded to the paper-making sheet (main body portion) obtained from Production Example 19 with an epoxy-based adhesive.

(I) Sheet containing polycarbonate resin;

(II) Sheet formed of resin composition containing flame retardant;

(III) Sheet formed of resin composition containing aromatic polyether resin;

(IV) Sheet containing waterproof resin layer; and

(V) Resin layer containing curable resin

As a result, in a case where a functional layer having a configuration of (I) described above was used, it was possible to obtain an article with excellent electromagnetic wave shielding properties and thermal conductivity and particularly excellent impact resistance. In a case where a functional layer having a configuration of (II) described above was used, it was possible to obtain an article with excellent electromagnetic wave shielding properties and thermal conductivity and particularly excellent flame retardance. In a case where a functional layer having a configuration of (III) described above was used, it was possible to obtain an article with excellent electromagnetic wave shielding properties and thermal conductivity and particularly excellent abrasion resistance. In a case where a functional layer having a configuration of (IV) described above was used, it was possible to obtain an article with excellent electromagnetic wave shielding properties and thermal conductivity and particularly excellent waterproof properties. In a case where a functional layer having a configuration of (V) described above was used, it was possible to obtain an article with excellent electromagnetic wave shielding properties and thermal conductivity and particularly excellent design properties.

Hereinbefore, the embodiments of the present invention have been described, but these are merely examples of the present invention and various configurations other than those described above can be employed.

This application claims priority based on Japanese Patent Application No. 2012-220293 filed on Oct. 2, 2012 and the entire disclose of which is incorporated herein.

1. An article comprising:
a main body portion that is formed of a material composition containing a fiber filler and a resin and obtained using a paper-making method; and
a functional layer that covers the main body portion.

2. The article according to claim 1, wherein the functional layer is a layer which is formed of a material composition containing a fiber filler and a resin and obtained using a paper-making method.

3. The article according to claim 1, wherein the fiber length of the fiber filler is equal to or more than 500 μm and equal to or less than 10 mm.

4. The article according to claim 1, wherein the content of the fiber filler is equal to or more than 1% by mass and equal to or less than 90% by mass based on the total content of the material composition.

5. The article according to claim 1,
wherein the fiber filler contains a metal element, and
the metal element contains at least one kind selected from a group consisting of iron, silver, nickel, aluminum, and copper.

6. The article according to claim 1, wherein the material composition further contains a powdery substance having ion exchange ability.

7. The article according to claim 1, wherein the material composition further contains at least one kind of filler powder selected from a group consisting of inorganic powder and metal powder.

8. The article according to claim 1, further comprising a metal layer formed of a metal.

9. A laminate comprising:
a first layer that is formed of a first material composition containing a first fiber filler and a first resin which binds the first fiber fillers to each other and is obtained using a paper-making method; and
a second layer that is formed of a second material composition containing a second fiber filler and a second resin which binds the second fiber fillers to each other and is obtained using a paper-making method,
wherein the first layer and the second layer are laminated with each other.

10. The laminate according to claim 9, wherein an opening portion is formed in the first layer.

11. The laminate according to claim 10, wherein the second layer is fitted to the opening portion.

12. The laminate according to claim 9, further comprising a third layer that is formed of a third material composition containing a third fiber filler and a third resin which binds the third fiber fillers to each other and is obtained using a paper-making method.

13. The laminate according to claim 9, further comprising a metal layer formed of a metal.

14. The laminate according to claim 12, wherein the lengths of the first, second, and third fiber fillers are equal to or more than 500 μm and equal to or less than 10 mm.

15. The laminate according to claim 12, wherein the contents of the first, second, and third fiber fillers are respectively equal to or more than 1% by mass and equal to or less than 90% by mass based on the total mass of the first, second, and third material compositions.

16. The laminate according to claim 12,
wherein the first, second, and third fiber fillers contain a metal element, and
the metal element contains at least one kind selected from a group consisting of iron, silver, nickel, aluminum, and copper.

17. The laminate according to claim 12, wherein the first, second, and third material compositions further contain a powdery material having ion exchange ability.

18. The laminate according to claim 12, wherein the first, second, and third material compositions further contain at least one kind of filler powder selected from a group consisting of inorganic powder and metal powder.

19. The laminate according to claim 9, wherein the laminate is subjected to a bending process.

20. The laminate according to claim 9, wherein the laminate has electromagnetic wave shielding performance.

21. The laminate according to claim 9, wherein the laminate is a case that accommodates an electronic device.
